(19) United States
(12) Patent Application Publication
(10) Pub. No.: US 2012/0216041 A1
(43) Pub. Date: Aug. 23, 2012

(54) SERVICE SYSTEM

(75) Inventors: Norihiko NAONO, Tokyo (JP); Tomohisa OTA, Tokyo (JP); Kunihiko OHNAKA, Tokyo (JP)

(73) Assignee: RIPPLEX INC., Tokyo (JP)

(21) Appl. No.: 13/403,031

(22) Filed: Feb. 23, 2012

Related U.S. Application Data
(63) Continuation of application No. PCT/JP2009/065116, filed on Aug. 28, 2009.

(51) Int. Cl. H04L 9/32

(52) U.S. Cl. 713/171

(57) ABSTRACT

Provided is a system including a first server which stores a first encryption key and a second server which stores a second encryption key. The first server has a storage unit which stores double encryption information obtained by subjecting the information to double encryption using a first encryption key and a second encryption key. The first server stores encrypted information obtained by encrypting the information by a third encryption key. The first server further stores a double encryption key obtained by encrypting the third encryption key and the second encryption key.

### CROSS REFERENCE TO RELATED APPLICATIONS

This application is a U.S. continuation application filed under 35 USC 111(a) claiming benefit under 35 USC 120 and 365(c) of PCT application JP2009/065116, filed on Aug. 28, 2009, the entire contents of which are incorporated by reference.

### BACKGROUND OF THE INVENTION

1. Field of the Invention

The present invention is related to a data process in which servers are linked and provide a service. In particular, the present invention is related to a data process for providing an online service.

2. Description of the Related Art

In recent years, various web services are provided by numerous providers on the internet. Electronic mail, chat, SNS (Social Networking Service), video, picture board, search, map, product sales, product delivery, etc. are among the widely used web services. As a result, one user can use many web services. For example, in the current situation, one internet user may have several electronic mail addresses, be a member of many SNS services, and use several product sale sites.

Consequently, the data owned by one user are distributed among various web services. That is, the data owned by one user is stored in different servers among various web service providers. Therefore, the data held and exchanged of each owner is separated resulting in a loss of convenience for each web service user.

In order to solve this problem, attempts have been made to increase the convenience for each user of web services by mutually utilizing the data of user among various web services. For example, it is possible to mutually utilize users' data between different services by allowing external access to an API (Application Program Interface) in each web service. For example, videos which are posted on video posting service named Youtube can be used on other web services via an API (ref. non-patent document 1 quoted below). The data of products sold on the product web service called Amazon can also be used on other web services via an API (ref, non-patent document 2 quoted below). The social graph API provided by Google Inc. has been formulated with the aim of using an acquaintance relationship between users while exceeding the boundaries of web services among optional web services (ref. non-patent document 3 quoted below).

The majority of data which is the object of mutual use of the data among different web services via these types of API can actually be accessed by anyone on the Internet. That is, it is public information. The data of users stored on each server is an invaluable asset for each web service provider. However, if those are originally made public on the Internet, the web service provider loses almost nothing via the mutual use of data via an API, and reversely, it is possible to promote the use of each web service by making the API public.

### DOCUMENTS RELATED TO PRIOR ART

### Non-Patent Document 1:

http://code.google.com/intl/ja-JP/apis/youtube/getting_started.html#data_api

### Non-Patent Document 2:

http://docs.amazonwebservices.com/AWSEcommerceService/4-0/

### Non-Patent Document 3:

http://code.google.com/intl/ja/apis/socialgraph/docs/api.html

### SUMMARY OF THE INVENTION

However, on the servers of various web services, there are a lot of data which are not made public on the internet. Typical non-public data include user ID data, user attribute data, acquaintance relationships, etc. For example, while the social graph API mentioned above is formulated with the aim of mutual use of ID data, this type of data such as acquaintance relationship, etc. is almost always not made public. As a result, web services which can obtain ID data or acquaintance relationships, etc. via the social graph API mentioned above are extremely limited and the social graph API mentioned above cannot realize its convenience and therefore is hardly used.

One reason that mutual use of data, which is not made public on the internet while exceeding we services, is obstructed is the circumstances of web service providers. Each web service provider wishes to use non-public data such as ID data, attribute data, acquaintance relationships, etc. on other web services in its own web services. On the other hand, he/she also does not want to provide non-public data within his/her own web services to other web service providers. Generally, this is because ID data, user attribute data, and acquaintance relationships are the source of profits for web service providers and also because they are the most important assets for attracting users to his/her own services rather than the services of other providers. That is, while each web service provider desires a link with other web services via an API, it also has the opposite desire to maintain the independence of its own web services.

While facing this situation, one embodiment of the present invention provides a method by which mutual use of a user's non-public data is possible in a state whereby independence of each web service provided using a server, a system, a data terminal, a network, etc. is maintained without allowing other web service providers to obtain non-public data while exceeding several web services

As one aspect of the present invention, disclosed is a system including a first server storing a first encryption key; and a second server storing a second encryption key; wherein the first server stores encrypted data encrypted by a third encryption key and stores a double encrypted key generated by double encrypting the third encryption key using the second encryption key and the first encryption key.

As another aspect of the present invention, disclosed is a system including a first server storing a first encryption key; a second server storing a second encryption key; and a third server; wherein the first server is arranged with a transmitter for transmitting the first encryption key to the third server; the third server is arranged with a receiver for receiving the first encryption key, an encrypted key generator for generating an encryption key by generating a third encryption key and by encrypting the third encryption key using the first encryption key and a transmitter for transmitting the encryption key to the second server; and the second server is arranged with a receiver for receiving the encryption key, a double encryption key generator for generating a double encryption key by double encrypting the encryption key using the second encryption key, and a transmitter for transmitting the double encryption key to the first server, the first server is arranged with a storage for storing the double encryption key.

As another aspect of the present invention, disclosed is a system including a first server storing a double encryption key produced by double encrypting a first encryption key using a second encryption key and a third encryption key, and the third encryption key; a second server storing the second encryption key; and a third server; wherein the first server is arranged with a transmitter for transmitting the double encryption key to the second server and for transmitting the third encryption key to the third server; the second server is arranged with a receiver for receiving the double encryption key, an encryption key generator for generating an encryption key by decrypting the double encryption key using the second encryption key, and a transmitter for transmitting the encryption key to the third server; and the third server is arranged with a receiver for receiving the encryption key, and an encryption key generator for generating the first encryption key by decrypting the encryption key using the third encryption key.

As another aspect of the present invention, disclosed is a server including a storage for storing a first encryption key; a receiver for receiving a encrypted data produced by encrypting data using a second encryption key from a first server, and for receiving a double encryption key from the second server, the double encryption key being produced by double encrypting the second encryption key using a third encryption key stored in the second sever and the first encryption key; and a storage for correlating the encryption data and the double encryption key with ID data by storing the encryption data, the double encryption key, and the ID data.

As another aspect of the present invention, disclosed is a server including a receiver for receiving data from a data terminal; an encryption key generator for generating a first encryption key; an encryptor for generating encrypted data by encrypting the data using the first encryption key; and a transmitter for transmitting the encrypted data to a first server; wherein the receiver receives a second encryption key from the first server, and is arranged with an encryption key generator for generating an encryption key produced by encrypting the first encryption key using the second encryption key; and the transmitter transmits the encryption key to a second server for generating a double encryption key by double encrypting the encryption key using a third encryption key stored in a second server.

As another aspect of the present invention, disclosed is a server including a receiver for receiving data from a data terminal; and a transmitter for transmitting an identification tag which uniquely identifies a user of the data terminal to a first server; wherein the receiver receives a first encryption key from the first server; an encryption key produced by decrypting a double encryption key using the third encryption key stored in a second server is received by the second server, the double encryption key being produced by double encrypting a second encryption key using a third encryption key and the first encryption key, the double encryption key being correlated with the identification tag and stored in a first server; an encryption key generator for decrypting the encryption key using the first encryption key and generates the second encryption key; and the transmitter for transmitting an encrypted data produced by encrypting the data using the second encryption key to the first server.

As another aspect of the present invention, disclosed is a server including: a receiver for receiving data from a data terminal; and a transmitter for transmitting an identification tag which uniquely identifies a user of the data terminal to a first server; wherein the receiver receives a first encryption key from the first server, and receives an encryption key from the second server, the encryption key being produced by decrypting a double encrypted key using a third encryption key stored in the second server, the double encryption key being produced by double encrypting a second encryption key correlated with the identification tag and stored in a first server, using the third encryption key and the first encryption key; the server is arranged with an encryption key generator for decrypting the encryption key using the first encryption key and generates the second encryption key; and the transmitter for transmitting an encrypted data produced by encrypting the data using the second encryption key to a fourth server.

As another aspect of the present invention, disclosed is a server including: a storage for storing a double encryption key produced by double encrypting an encryption key which is produced by encrypting a first encryption key, a second encryption key and data using the second encryption key, the double encryption key being produced by a third encryption key stored by a first server and the first encryption key; and a transmitter for transmitting the first encryption key to the second server and sends the double encryption key to the first server.

As another aspect of the present invention, disclosed is a server including: a receiver for receiving an encryption key produced by encrypting a first encryption key and data using a second encryption key from a first server, and receives an encryption key produced by encrypting the second encryption key using the first encryption key from a second server; an encryptor for decrypting the encryption key using the first encryption key to generate the second encryption key; a decryptor for decrypting the encryption key using the second encryption key to generate the data; and a transmitter for transmitting the data to a data terminal.

As another aspect of the present invention, disclosed is a system including: a first server which stores a first encryption key; and a second server which stores a second encryption key; wherein the first server is arranged with a storage for storing a double encryption key produced by double encrypting data using the first encryption key and the second encryption key.

As another aspect of the present invention, disclosed is a system including: a first server which stores a first encryption key; a second server which stores a second encryption key; and a third server wherein the third server is arranged with a storage for storing a double encryption key produced by double encrypting data using the first encryption key and the second encryption key.

As another aspect of the present invention, disclosed is a system including: a first server which stores a first encryption key; a second server which stores a second encryption key; a third server; and a data terminal wherein the third server is arranged with a receiver for receiving data from the data terminal, the first encryption key from the first server and the second encryption key from the second server, and an encryptor for double encrypting the data using the first encryption key and the second encryption key, and the first server is arranged with a storage for storing the double encryption data.

As another aspect of the present invention, disclosed is a system including: a first server which stores a first encryption key; a second server which stores a second encryption key; a third server; a fourth server; and a data terminal wherein the third server is arranged with a receiver for receiving data from the data terminal, the first encryption key from the first server and the second encryption key from the second server, and an encryptor for double encrypting the data using the first encryption key and the second encryption key, and the fourth server is arranged with a storage for storing the double encryption data.

As another aspect of the present invention, disclosed is a server including: a receiver for receiving first data from a data terminal, a first encryption key from a first server and a second encryption key from a second server; an encryptor for generating first double encryption data produced by double encrypting the first data using the first encryption key and the second encryption key; and a transmitter for transmitting the first double encryption data to the first server.

As another aspect of the present invention, disclosed is a server including: a receiver for receiving first data from a data terminal, a first encryption key from a first server and a second encryption key from a second server; an e encryptor for generating first double encryption data produced by double encrypting the first data using the first encryption key and the second encryption key; and a transmitter for transmitting the first double encryption data to the third server.

As another aspect of the present invention, disclosed is a server including: a receiver for receiving a first encryption key from a first server, a second encryption key from a second server, and a first double encrypted data produced by double encrypting first data received from the server using the first encryption key and the second encryption key; a decryptor for decrypting the first double encrypted data into a first data by decrypting the first double encrypted data using the first encryption key and the second encryption key; and a transmitter for transmitting the first data to a data terminal.

### BRIEF DESCRIPTION OF THE DRAWINGS

FIG. 1 is a schematic structural diagram of a system comprised of a data terminal and a server apparatus in one embodiment of the present invention,

FIG. 2 is a schematic structural diagram of a data process server apparatus of a security service X in one embodiment of the present invention,

FIG. 3 is a schematic structural diagram of a data storage server apparatus of a security service X in one embodiment of the present invention,

FIG. 4 is a schematic structural diagram of a server apparatus of a web service Y in one embodiment of the present invention,

FIG. 5 is a schematic structural diagram of a server apparatus of a web service Z in one embodiment of the present invention,

FIG. 6 is a schematic structural diagram of a data terminal in one embodiment of the present invention,

FIG. 7 is a flow chart which explains a process of storing data in a security service X when a user A uses a web service Y in one embodiment of the present invention,

FIG. 8 is a diagram which represents one example of a display screen of a data terminal of a user A in one embodiment of the present invention,

FIG. 9 is a diagram which shows an example of an encryption key table of a server apparatus of a web service Y in one embodiment of the present invention,

FIG. 10 is a diagram which shows an example of a user encryption key table of a data storage server of a security service X in one embodiment of the present invention,

FIG. 11 is a diagram which shows an example of an encryption data table of a web service Y in one embodiment of the present invention,

FIG. 12 is a flow chart which explains a process for acquiring data from a security service X when a user A uses a web service Y and displaying the data on an information terminal in one embodiment of the present invention,

FIG. 13 is a table which illustrates various cases of encryption keys and encrypted data in one embodiment of the present invention,

FIG. 14 is a table which illustrates various cases of encryption keys in two embodiments of the present invention,

FIG. 15 is a flow chart which explains a process for storing data in a security service X when a user A uses a web service Y in one embodiment of the present invention,

FIG. 16 is a diagram which shows an example of a service encryption table of a security service X in one embodiment of the present invention,

FIG. 17 is a diagram which shows an example of an encryption data table of a security service X in one embodiment of the present invention,

FIG. 18 is a flow chart which explains a process for storing data in a security service X when a user A uses a web service Y in one embodiment of the present invention,

FIG. 19 is a flow chart which explains a process for storing data in a security service X when a user A uses a web service Y in one embodiment of the present invention,

FIG. 20 is a flow chart which explains a process for acquiring data from a security service X when a user A uses a web service Y and displaying the data on a data terminal in one embodiment of the present invention, and

FIG. 21 is a diagram which represents an example of a display screen of a data terminal of a user A in one embodiment of the present invention.

### DETAILED DESCRIPTION OF THE INVENTION

The preferred embodiments for realizing the invention are explained below. The scope of the present invention is clearly defined by the scope of the appended claims and therefore the explanation below is not intended to be interpreted in a limited meaning and aims to simply exemplify the general principles of the invention.

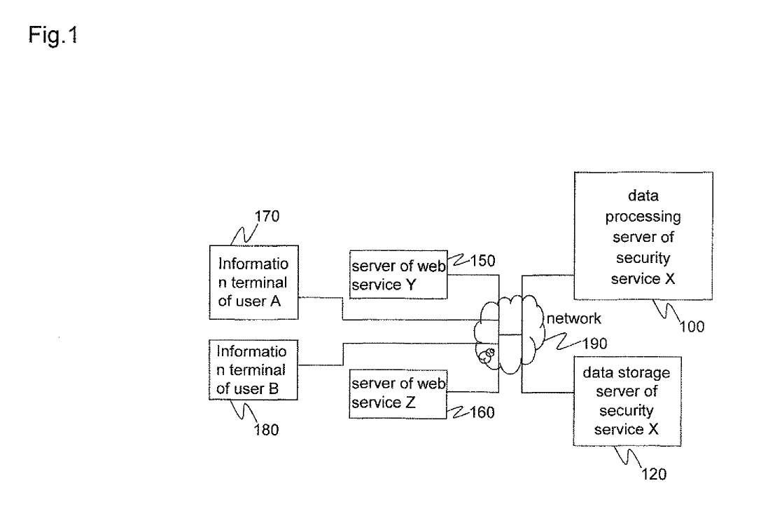

FIG. 1 is a schematic structural diagram of a system in one example of one embodiment of the present invention. In FIG. 1, a schematic structure of a system for storing and browsing data is shown. Data processing server 100 of a security system X and a data storage server 120 of a security system X are connected to a server 150 of a web service Y, a server 160 of a web service Z, a data terminal 170 of a user A and a data terminal 180 of a user B via a network 190. The server 100 and the server 120 may be connected via the network 190, via a different network, or directly connected.

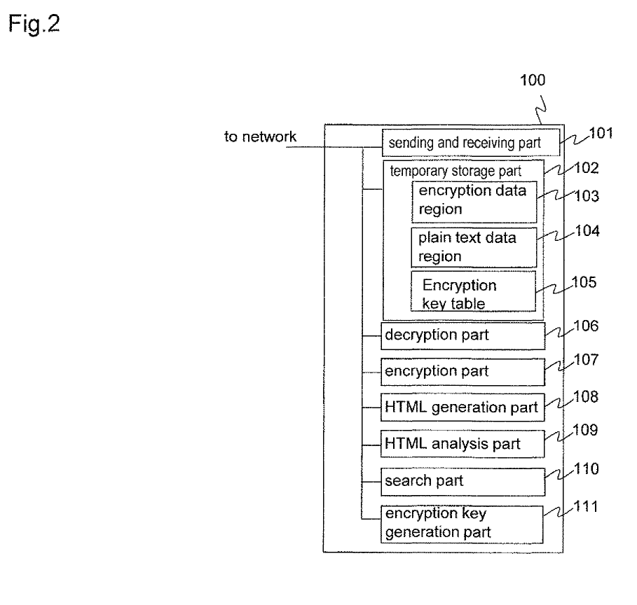

FIG. 2 shows a schematic structural diagram of the data processing server 100 of the security service X. The data processing server of the security service X includes a sending and receiving part 101, a temporary storage part 102, a decryption part 106, an encryption part 107, an HTML generation part 108, an HTML analysis part 109, a search part 110, and an encryption key generation part 111. The temporary storage part 102 includes an encryption data region 103, a plain text data region 104 and an encryption key table 105.

Furthermore, the sending and receiving part may be divided into a sending part which provides a function for sending and a receiving part which provides a function for receiving. The same is also the case for other sending and receiving parts of a server and a data terminal.

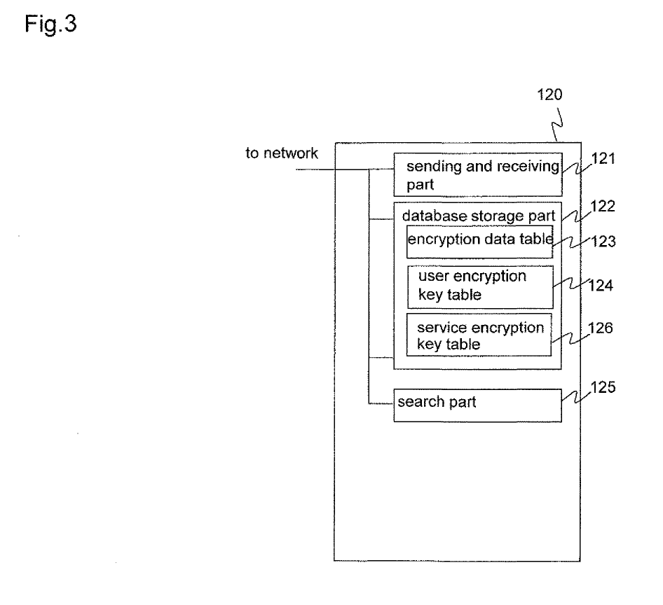

A schematic structure of the data storage server 120 of the security service X is shown in FIG. 3. The data storage server 120 of the security service X includes a sending and receiving part 121, a database storage part 122, and a search part 125. The database storage part 122 includes an encryption data table 123, a user encryption key table 124, and a service encryption key table 126.

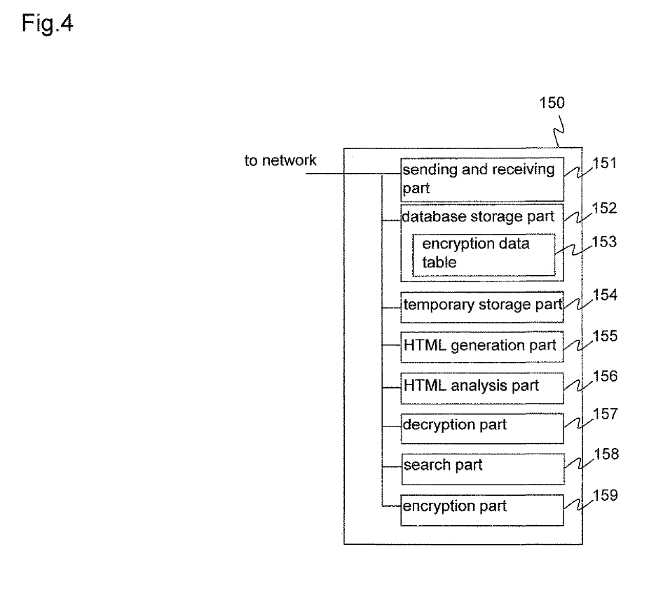

A schematic structure of the server 150 of the web service Y is shown in FIG. 4. The server of the web service Y includes a sending and receiving part 151, a database storage part 152, a temporary storage part 154, an HTML generation part 155, an HTML analysis part 156, a decryption part 157, a search part 158, and an encryption part 159. The database storage part 152 includes an encryption key table 153.

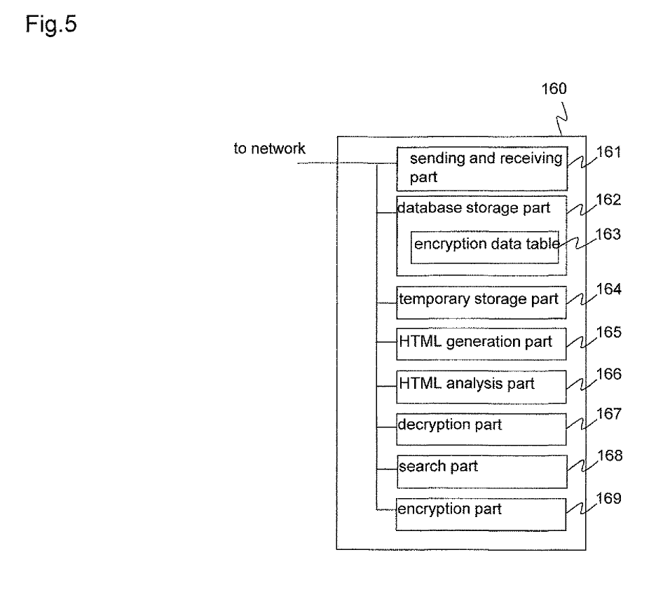

A schematic structure of the server 160 of the web service Z is shown in FIG. 5. The server of the web server Z includes a sending and receiving part 161, a database storage part 162, a temporary storage part 164, an HTML generation part 165, an HTML analysis part 166, a decryption part 167, a search part 168, and an encryption part 169. The database storage part 162 includes an encryption key table 163.

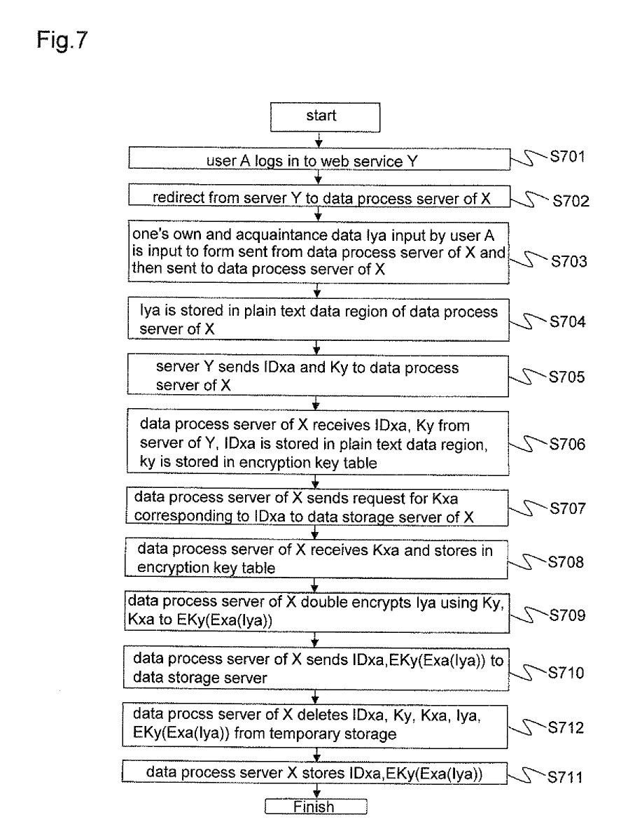

Furthermore, the temporary storage part of each server is realized by a storage part. This type of storage part is structured using a memory element such as a DRAM (Dynamic Random Access Memory) and such, for example. In the temporary storage parts, data which is stored for each process is deleted when the processes related to the present invention are completed as is explained in each flow chart of FIGS. 7, 12, 18, 19 and 20 below. It is preferred that the data stored in the temporary storage part is not stored indefinitely in a server such as in a database. For example, a provider of a security service or a web service cannot search data stored in a temporary storage part at any time. It is preferred that the temporary storage part is for temporarily storing data for only the duration of time required for a process. So long as data can be deleted, the temporary storage can be realized by a non-volatile storage device such as a hard disk drive or a Flash memory, etc., other than a main storage device of a server comprised of a DRAM, etc.

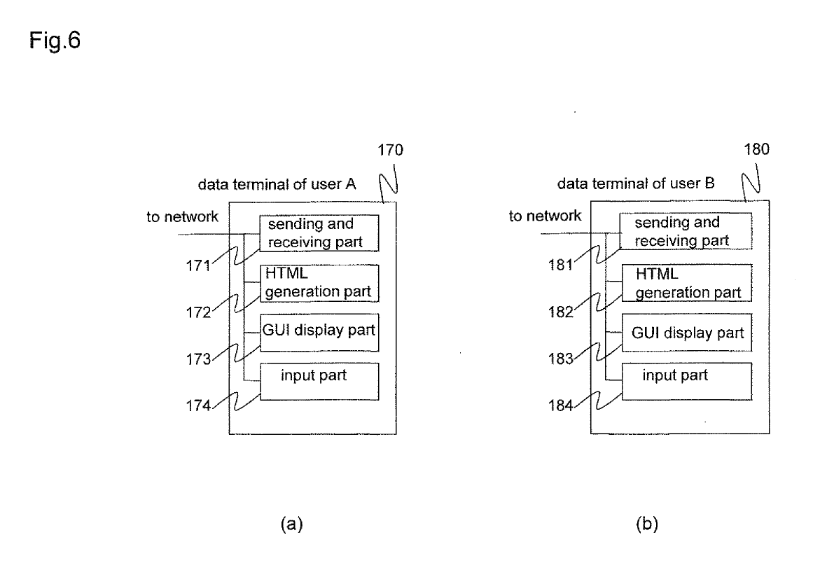

A schematic structure of the data terminal 170 of the user A is shown in FIG. 6 (a). In addition, a schematic structure of the data terminal 180 of the user B is shown in FIG. 6 (b). The data terminal 170 of the user A includes a sending and receiving part 171, an HTML analysis part 172, a GUI display part 173, and an input part 174. The data terminal 180 of the user B includes a sending and receiving part 181, an HTML analysis part 182, a GUI display part 183, and an input part 184.

### First Embodiment

First, an outline of the first embodiment is explained. In the first embodiment, as is shown in FIG. 1, a user A who uses the web service Y communicates with the server 150 of the web service Y via the data terminal 170. At this time, user A wishes to prevent the data which sent by user A via the data terminal 170 from being stored in the server 150 of the web service Y and also wishes to prevent the data from being browsed by the provider of the web service Y. For example, suppose the web service Y is an address record web service which manages the names and addresses of user A and acquaintances of user A. At this time, according to a conventional method, the names and addresses of user A and the acquaintances of user A are all stored in the server 150 of the web service Y. In this case, there is a risk of data leaks from the server 150 of the web service Y. In addition, user A may not want the stored data being used for advertising, etc. by the provider of the web service Y. In particular, according to a conventional method, because the data of acquaintances input by user A is stored in the server 150 of the web service Y without permission of the acquaintances who are the owner of the data, there is a greater desire to reduce the risk of a leak or to avoid the use of such data by the provider of the web service Y rather than the names and addresses, etc. of user A himself. Furthermore, here, although the web service Y and the web service Z are presumed to be address record web services as an example in order to explain the general principles of the present invention, they may also be services providing electronic mail, chat, SNS (Social Networking Service), product sales, product delivery, etc.

In the present embodiment, the data which user A wishes to keep secret from the web service Y is first sent to the data process server 100 of the security service X via the network 190 from the data terminal 170 of user A. Next, in the data process server 100 of the security service X, the data which is received is double encrypted and stored by the data storage server 120 of the security service X. This encryption uses two encryption keys. The first encryption key is stored in the server 150 of the web service Y. And the second encryption key is stored in the data storage server 120 of the security service X. At the time of this encryption, the first and second encryption keys are sent to the data process server of the service X via the network 190 and the encryption is performed. The encrypted data which is generated at this point becomes data which is not be able to be decrypted to plain text unless both the first and the second encryption keys are given at the same time.

Here, the first encryption key, the second encryption key, and the plain text data which are received in the data process server 100 of the security service X are all deleted after the double encryption. In addition, the first encryption key, the second encryption key, and the plain text data which are received are all deleted after the double encryption even if they have been stored in a database storage part. Here, a database storage part refers to a part which stores data persistently. In addition, the double encrypted data is stored in an encryption data table 123 of the database storage part 122 of the data storage server 120 of the security service X. While the server 150 of the web service Y stores the first encryption key, it does not hold the encryption data. While the data storage server 120 of the security service X stores both the encryption data and the second encryption key, it does not store the first encryption key. Given this situation, it is difficult for the provider of the security service X and the provider of the web service Y to obtain the plain text data of user A and the acquaintances of user A. In addition, even if encryption data of user A is leaked from the data storage server 120 of the security service X, the data cannot be recovered to a plain text as long as the first encryption key is not obtained from the server 150 of the web service Y, and therefore has a higher level of safety compared to the conventional method.

Next, the process of the present embodiment is explained in detail with reference to the flow charts of FIG. 7. Furthermore, in the flow charts of FIG. 7 and of other drawings, the server of the web service Y is abbreviated to server Y. Now, user A logs in to the service Y (step S701). At this time, the HTML generation part 155 of the server of the web service Y generates an HTML code, and the sending and receiving part 151 sends the HTML code to the data terminal 170 of user A via the network 190. The sending and receiving part 171 of the data terminal of user A receives the HTML code, the HTML analysis part 172 analyses the HTML code and the GUI display part 173 displays an image. At this point, user A is logging in to the web service Y and IDya, which is for uniquely identifies user A in the web service Y, is stored in a temporary storage part 154 of the server of the web service Y. Furthermore, in the present invention, data for identifying a user is sometimes referred to as an identification tag. The IDya mentioned above, a mail address, and data which is capable of identifying an individual such as a name and an address are examples of identification tags.

Furthermore, an HTML code is an example of a code for displaying data on the GUI display part 173 and any optional code may be used.

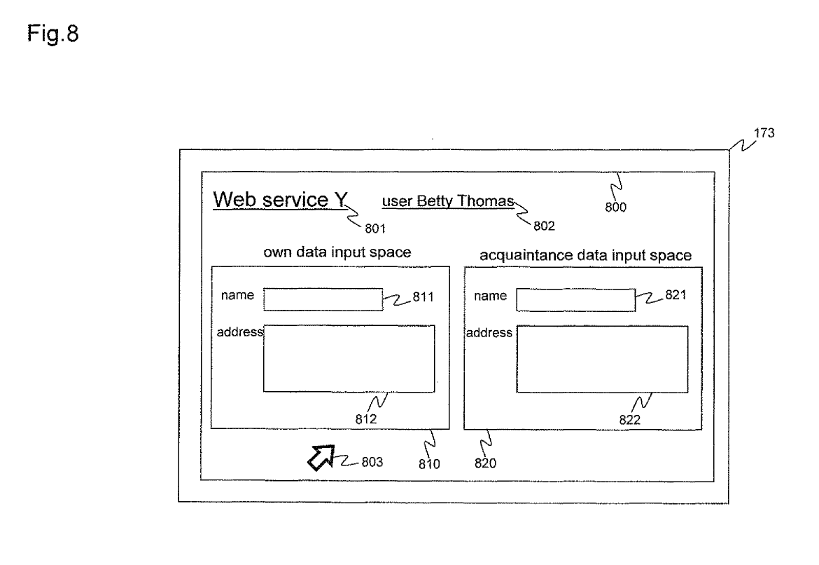

Now, the server of the web service Y requests user A to input data which is not to be stored in the server 150 of the web service Y. At this time, the connection between the server 150 of the web service Y and the data terminal 170 of user A is redirected to the data process server 100 of the security service X (step S702). That is, the state of the data terminal 170 transfers from a state of communication with the server 150 to a state of communication with the server 100. Next, the HTML generation part 108 of the data process server of the security service X generates an HTML code, and the sending and receiving part 101 sends the HTML code to the data terminal 170 of user A via the network 190. The sending and receiving part 171 of the data terminal of user A receives the HTML code and after an analysis by the HTML analysis part 172 an image is displayed by GUI display part 173. Here, an input form of names and addresses of user A and an acquaintance of user A such as shown in FIG. 8 are displayed as an example of the present embodiment.

Referring to FIG. 8, a display window 800 of a web browser is displayed on the GUI display part 173. Furthermore, a display 801 for displaying the fact that user A is currently using the web service Y via a web browser may be displayed in the display window 800 of the web browser. In the case where it is desired to display some information form of data held by the web service Y, this type of data is sent from the server 150 of the web service Y to the data process server 100 of the security service X, the data is temporarily stored in the plain text data region 104 and the HTML generation part 108 of the security service may generate an HTML code for displaying an image such as that shown in FIG. 8 using this. For example, in the example shown in FIG. 8, data held by the web service Y such as the name (Betty Thomas) 802 of user A is sent from the server 150 of the web service Y to the data process server 100 of security service X and converted to an HTML code by the HTML generation part 108. In this case, the data received from the server 150 of the web service Y is deleted together with other data in step S711 described below.

Referring again to FIG. 8 further, one's own data input space 810 and a data input space of an acquaintance 820 are displayed in the display windows 800 of the web browser. One's own data input space 810 includes a window 811 for inputting one's own name and a window 812 for inputting one's own address. The data input space of an acquaintance 820 includes a window 821 for inputting the name of the acquaintance and a window 822 for inputting the address of the acquaintance. In the example shown in FIG. 8, the data input space of the acquaintance 820 includes a window for inputting the name and address of one acquaintance. However, in the present embodiment, the data input space of the acquaintance 820 may include a window for inputting names and addresses of several acquaintances. In addition, FIG. 8 is an example of inputting both one's own and an acquaintance's names and addresses. However, in the present embodiment, a window for inputting other data may also be included. In addition, FIG. 8 is one example of the present embodiment and the data requested to be input to the data terminal of user A may be any data not only a name and an address.

Next, user A inputs his own data and the data of an acquaintance from the input part 174 of the data terminal 170 of user A. Now, the character strings input here and concatenated using spacing, etc. are denoted as data Iya. The sending and receiving part 171 of the data terminal 170 of user A sends Iya to the data process server 100 of the service X via the network 190 (step S703). The sending and receiving part 101 of the data process server of the service X receives Iya, which is temporarily stored in a plain text data region 104 of the temporary storage part 102 (step S704). Here, for simplification, although the character strings input to several fields are denoted as combined data Iya, these could also be divided into several data.

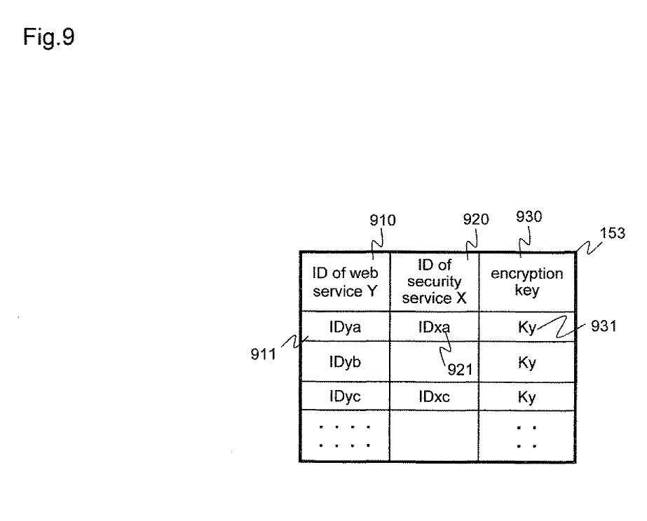

Next, the server 150 of the web service Y searches the encryption table 153 for IDya, which is the ID of user A and stored in the temporary storage part 154, as a search key. An example of the encryption table 153 is shown in FIG. 9. The encryption table includes a column 910 for storing IDs of users of the web service Y, a column 920 for storing IDs in the security service X, and a column 930 for storing the encryption keys stored in the server 150 of the web service Y. Here, the column 920 of the security service X and the column 930 of the encryption keys are searched for IDya 911, which is the ID of user A in the web service Y, as a search key, and IDxa 921, which is the ID of user A in the security service X, and Ky 931, which is the encryption key in web service Y, are obtained as a search result. Furthermore, here, although an example is explained whereby IDxa 921 is stored in the encryption key table 124 in advance, if IDxa 921 does not exist in the encryption key table 124, it may be obtained by sending a request for issuing an ID of user A in the security service X to the data storage server of the security service X, storing the ID in the encryption key table 153 and proceeding to the next step.

Here, with regard to a denotation of ID, in the case of IDmn, m represents a service and n represents a user. For example, IDya represents the ID of user A in the web service Y. In addition, similarly with regard to a denotation of an encryption key, in the case of Km, m represents a service. For example, Ky represents an encryption key stored in the server 150 of the web service Y. In addition, when an encryption key is denoted as Kmn, represents a service and n represents a user. For example, Kxa represents the encryption key of a user A in the security service X.

Next, the sending and receiving part 151 of the web service Y sends IDxa, which is the ID of user A in the security service X, and the encryption key Ky, which are the search result, to the data process server 100 of the service X via the network 190 (step S705). When the sending and receiving part 101 of the data process server of the service X receives IDxa and Ky, IDxa is stored temporarily in the plan text data region 104 of the temporary storage part and Ky is temporarily stored in the encryption key table 105 (step S706).

Next, the encryption part 107 of the data process server of the security service X sends a request signal for the encryption key of user A stored in the security service X to the data storage server 120 of the service X via the sending and receiving part 101 and the network 190. The request signal includes IDxa which is the ID of user A in the security service X received from the server 150 of the web service Y in step S705 described above (step S707).

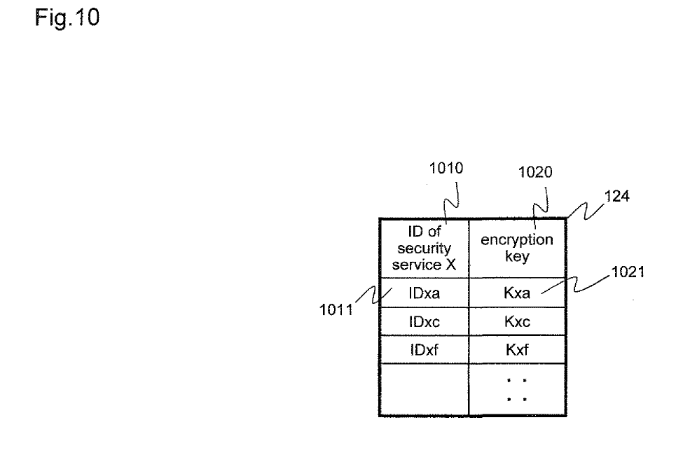

When the sending and receiving part 121 of the data storage server of the security service X receives the request signal, the search part 125 searches the user encryption key table 124 in the database storage part 122 for IDxa received by the search part 125 as a search key. An example of the user encryption key table 124 is shown in FIG. 10. The user encryption key table 124 in the present embodiment includes a column 1010 for storing IDs in the security service X and a column 1020 for storing an ID of security service X. The encryption key Kxa 1021 is obtained as a result of the search with IDxa 1011 as a search key. In the case where there is no encryption key correlated with IDxa, Kxa is generated. Next, the sending and receiving part 121 of the data storage server of the security service X sends Kxa to the data storage server 100 of the security service X via the network 190.

Next, when the sending and receiving part 101 of the data storage server of the security service X receives Kxa, it is stored in the encryption key table of a volatile storage region (step S708). At this time, by the process described above, the encryption key Ky obtained from the server of the web service Y in step S706, and the encryption key Kxa obtained from the data storage server of the security service X in step S708 are temporarily stored in an encryption key table.

Next, the encryption part 107 performs a doubly encryption on data Iya, which is stored in the plain text data region 104 in step S704, using the encryption key Ky stored in step S706 and the encryption key Kxa stored in step S708 (step S709). For example, as an example of the present embodiment, in the case where each of Ky and Kxa is a symmetrical key, the result of the double encryption is denoted as E_{Ky} (E_{Kxa} (Iya)). This denotation represents the result of encryption using Ky of the result of encrypting of Iya using Kxa. Furthermore, if the encryption order is reversed, the double encryption result E_{Kxa} (E_{Ky} (Iya)) is also possible. In addition, the process of encryption, which is used, may be any encryption process where decryption is not possible without both encryption keys Ky and Kxa, such as when Iya is encrypted using a calculation result of each of Ky and Kxa as an encryption key.

In addition, a symmetrical key or a non-symmetrical key may be used in the encryption in the steps explained hereto. In the case where a non-symmetrical key is used, Ky which is stored in the server of the web service Y and Kxa which is stored in the data storage server of the security service X are secret keys of user A, and encryption in step S709 is performed using public Ieys corresponding to Ky and Kxa respectively. Explanation is continued bellow assuming the result of double encryption data is denoted as E_{Ky} (E_{Kxa} (Iya)).

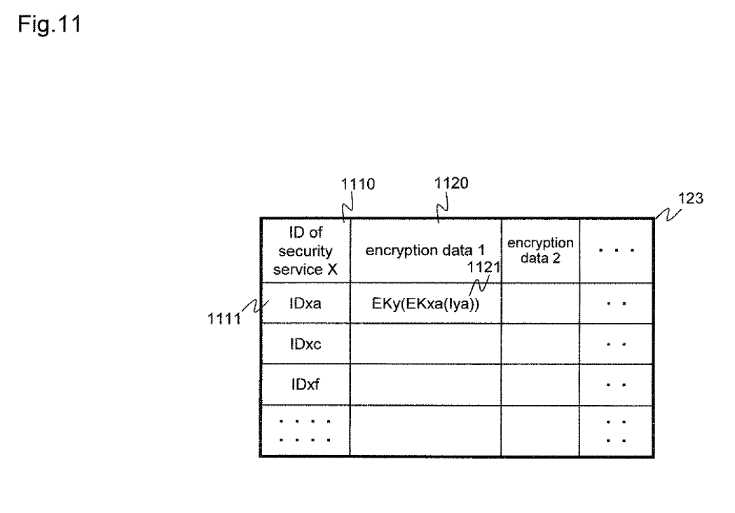

Double encryption data E_{Ky} (E_{Kxa} (Iya)) is temporarily stored in the encryption data region 103 of the temporary storage part. Next, IDxa of user A stored in the plain text storage region 104 in step 706 and the double encryption data E_{Ky} (E_{Kxa} (Iya)) stored in the encryption data region 103 in step S709 are sent to the data storage server 120 of the security service X via network 190 by the sending and receiving part 101 (step S710). The data process server 120 of the security service X deletes IDxa, Ky, Kxa, Iya and E_{Ky} (E_{Kxa} (Iya)) from the temporary storage part 102 (step S711). If the data sent from the server 150 of the web service Y to the data process server 100 of the security service X in step S702 is temporarily stored in temporary storage part 102, this is also deleted in step S711. Next, when the sending and receiving part 121 of the data storage server 120 of the security service X receives the data sent in step S710, this data is stored in the encryption data table 123 of the database storage part (step S712). An example of the encryption data table 123 in the present embodiment is shown in FIG. 11. The encryption data table 123 includes a column for storing IDs in the security service X and a column for storing one or more encryption data. The encryption data E_{Ky} (E_{Kxa} (Iya)) stored in step S711 is stored in a row IDxa 1111. Furthermore, as can be seen from FIG. 10 and FIG. 11, in the present embodiment, an encryption key Kxa 1021 and a double encryption data E_{Ky} (E_{Kxa} (Iya)) are both stored together in the data storage server of the security service X. However, an encryption key and a double encryption key may also be stored in different servers.

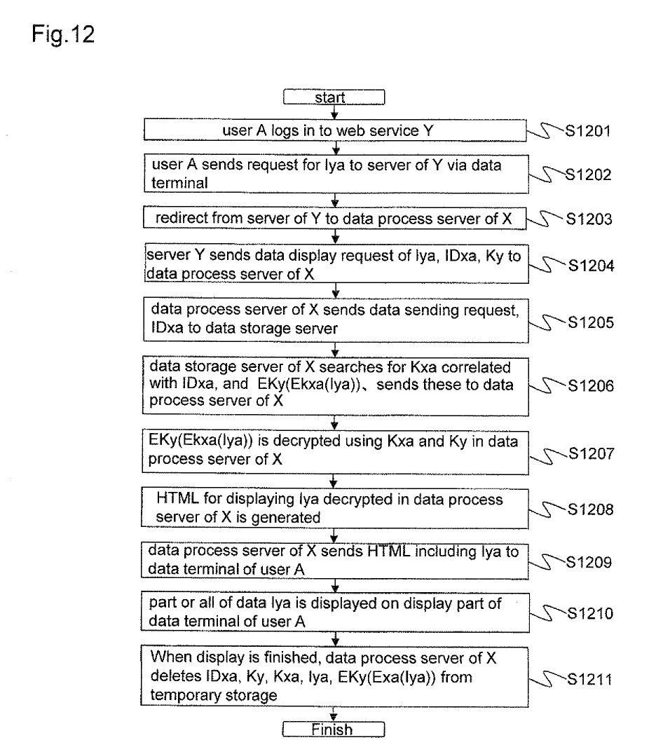

Next, the process whereby user A browses his/her own and his/her acquaintance's data Iya, which has been input in step S703 via the web service Y, is explained using the flow chart in FIG. 12.

Now, user A is logging in to web service Y (step S1201). At this time, the result of an analysis by the data terminal of user A on the HTML code sent from the web service Y is displayed on the GUI display part 173 of the data terminal of the user A. Here, an operation is carried out for acquiring data related to user A him/herself and an acquaintance, which has been input via input part 174 by user A. Then, the sending and receiving part 171 of the data terminal of user A sends a display request of Iya to the server 150 of the web service Y via the network 190 (step S1202). The sending and receiving part 101 of the web service Y which receives this request redirects the connection to the data terminal 170 of user A to the data process server 100 of the security service X (step S1203).

Furthermore, the search part 158 of the server of the web service Y searches the encryption key table 153, which is in a database storage part, for IDya for uniquely identifying user A on web service Y as a search key. Again referring to FIG. 9, IDxa 921 and Ky 931 are obtained as the search result. Next, a request for Iya is sent together with IDxa and Ky to the data process server 100 of security service X via the network 190 (step S1204). In the data process server of the security service X which receives these, Ky is stored in the encryption key table 105 of the temporary storage part and IDxa is stored in the plain text data region 104 respectively.

Next, the sending and receiving part 101 of the data process server of the security service X sends a request to obtain a double encryption data of Iya together with IDxa received from the server of web service Y to the data storage server 120 of the security service X via the network 190 (step S1205). When the sending and receiving part 121 of the data storage server of the security service X receives this request, the search part 125 searches the encryption data table 123 and the encryption key table 124 for the received IDxa as a search key. Again referring to FIG. 11, the double encryption data E_{Ky} (E_{Kxa} (Iya)) 1121 is obtained as a search result by a search of the encryption data table 123. In addition, the encryption key Kxa of user A in the security service X is obtained by a search of the encryption key table 124. The sending and receiving part 121 sends the encryption data E_{Ky} (E_{Kxa} (Iya)) and the encryption key Kxa to the data process server 100 of the security service X via the network 190 (step S1206).

In the data process server of the security service X the sending and receiving part 101 receives this data and the double encryption data E_{Ky} (E_{Kxa} (Iya)) is correlated with IDxa then stored in the encryption data region 103 of the temporary storage part and the encryption key Kxa is correlated with IDxa then stored in the encryption key table 105. Next, a decryption part 106 decrypts the encryption data E_{Ky} (E_{Kxa} (IA) using Ky and Kxa, Kxa being stored in the encryption table, Ky being received from the server of web service Y in step S1204 (step S1207), and the data Iya is obtained. This Iya is temporarily stored in the plain text data region 104 of the temporary storage part and the HTML generation part generates an HTML code which includes a part or all of this data (step S1208). The HTML code generated here is sent to the data terminal 170 of user A by the sending and receiving part 101 via the network 190 (step S1209). Data held by the server 150 of the web service Y is required for the generation of this HTML code. This data may be separately received from the server of web service Y, be stored in the plain text data region 104, and be included in the HTML code generated in step S1208. Here, in the case where there is data received from the server 150 of the web service Y and stored, this data is deleted together with other data in step S1211.

When the sending and receiving part of the data terminal of user A receives the HTML code, the HTML analysis part analyses the HTML code and the GUI display part displays a screen which includes the data Iya, that is, a part or all of the data of the user A and the acquaintance of user A, which has been input in step S703 (step S1210). It is preferred that IDxa, Ky, Kxa, Iya and E_{Ky}(E_{Kxa} (Iya)) which are stored in the temporary storage part 102 of the data process server of the security service X are all deleted by the time this display is completed. A process for displaying data which is previously input on web service Y by user A on the display part of the data terminal is completed.

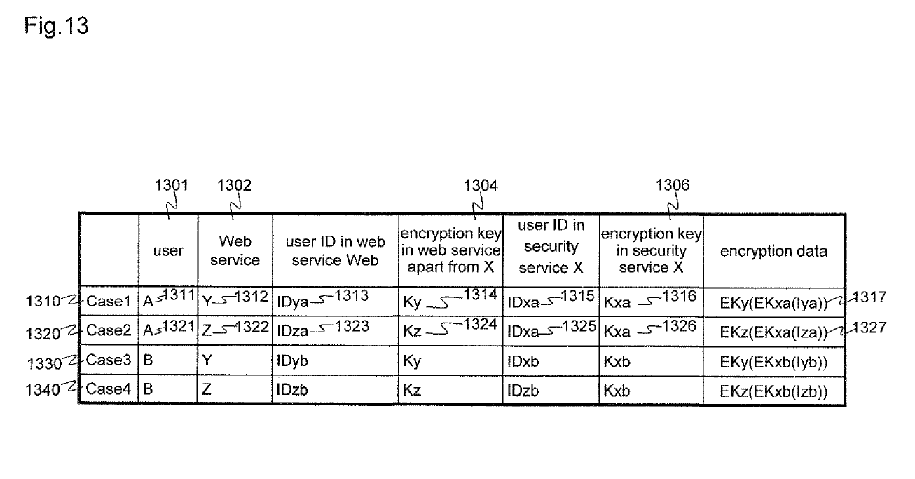

The process explained with reference to flow charts of FIG. 7 and FIG. 12 is a process for safely storing, by a use of the security service X, the data Iya, which is necessary for inputting or browsing when user A uses the web service Y via the data terminal 170. The process explained hereto is referred to “case 1” hereinafter. Next, a process for safely storing, by a use of the security service X, a data Iza, which is necessary for inputting or browsing when user A uses the web service Z via the data terminal 170 is explained as “case 2.” However, because the process of the case 2 is almost the same as the process explained with reference to flow charts in FIG. 7 and FIG. 12, the differences are simply explained with reference to FIG. 13 without repeating the above explanation.

In FIG. 13, a comparison of the case 1, which is explained with reference to flow charts FIG. 7 as well as FIG. 12 and an example of the process explained below, is shown. The first row 1310 of the table shown in FIG. 13 corresponds to the case 1. The process in the case 1 is for safely storing and browsing data Iya in the case where user A uses the web service Y1312. In the case 1, user A has IDya 1313 for uniquely identifying user A in the web service Y and IDxa 1315 for uniquely identifying user A in the security service X. Furthermore, in the case 1, two keys which are used in the double encryption at the security service X are the encryption key Ky 1314 stored in the server of the web service Y and the encryption key Kxa 1316 stored in the data storage server of the security service X. In addition, the data which underwent a double encryption in the case 1 is E_{Ky} (E_{Kxa} (Iya)).

The second row 1320 in FIG. 13 corresponds to the case 2. The process in the case 2 is for safely storing and browsing the data Iza in the case where user A 1321 uses the web service Z 1322. In the case 2, user A has IDza 1323 for uniquely identifying user in web service Z, and IDxa 1325 for uniquely identifying user A in the security service X. Furthermore, in the case 2, two keys used in a double encryption at the security service X are an encryption key Kz 1324 stored in the server of web service Z and an encryption key Kxa 1326 stored in the data storage server of the security service X. In addition, the data which undergoes a double encryption in the case 2 is E_{Kz} (E_{Kxa} (Iza)). The process in the case 2 is obtained by replacing, in the flow charts of FIG. 7 and FIG. 12 with regards to case 1, the symbols in the first row with the symbols of the second row in FIG. 13.

Similarly, processes for safely storing data Iyb which is required for input or browsing when user B uses web service Y via data terminal 180 are shown in the third row 1330 of FIG. 13 as the case 3. In addition, similarly, processes for safely storing data Izb which is required for input or browsing when user B uses web service Z via the information terminal 180 are shown in the fourth row 1340 of FIG. 13 as the case 4.

Furthermore, in the present embodiment, when data Iya is double encrypted using encryption key Ky and encryption key Kxa, first encryption data E_{Kxa}(Iya) which is produced by encrypting Iya using Kxa is generated and double encryption data E_{Ky}(E_{Kxa}(Iya)) which is produced by encrypting this encryption data using Ky is generated. In addition, double encryption data E_{Ky}(EKxa(Iya)) is decrypted by a reverse process and plain text data Iya is generated. By reversing the order of this encryption, encryption data E_{Ky}(Iya) may be generated by first encrypting data Iya using encryption key Ky, and double encryption data E_{Kxa}(E_{Ky}(Iya)) may be generated by encrypting this encryption data using Kxa. Furthermore, the double encryption data may be Kf (Iya) which is generated with an arbitrary calculation result Kf which is uniquely determined using Kxa and Ky. That is, as an double encryption in the present embodiment, any method may be used as long as it is an encryption method which requires the two keys Ky and Kxa when decrypting double encryption data to plain text data Iya.

Next, the effects of the present embodiment are explained. The first effect of the present embodiment is that it is possible to provide each web service without storing data which is input by a user, for example, data which should be protected such as Iya in the server of a web service. For example, in the case 1, referring to FIG. 9, data of user A stored in the database storage part 152 of the server 150 of web service Y is only IDya 911, IDxa 912, and Ky 913. Even if this data is leaked from the server 150 of web service Y, the data Iya of user A which should be protected is not includes and cannot be decrypted. Using the present invention it is possible to provide the effects of safety with regards to data secrecy to a user and the effects of reducing the risk of user data leaks to a provider of the web service Y.

Many web services users do not want their data used by the web service provider in the case of inputting their own or their acquaintance's data to the web service. For example, a web service user may not want to receive advertisements or messages from the web service provider. Furthermore, many web service users may worry that their own or acquaintances data may be leaked.

In addition, there is a risk of a claim for compensation to a web service provider or harmful rumors being produced when data of a user or the user's acquaintance is leaked. Furthermore, it is often not possible to obtain users' data or their acquaintance data and storing this data in a server of a web service reflecting laws or regulations for limiting the acquirement of personal data. The first effect of the present embodiment is useful in solving this type of problem.

The second effect of the present invention is that it is possible to realize a high level of safety because data input by a user which should be protected such as Iya is double encrypted in a form of E_{Ky}(E_{Kxa}(Iya)) and stored in the data storage server of the security service X. For example, in the case 1, referring to FIG. 10 and FIG. 11, the data which is stored in the data storage server 120 of the security service X is only IDxa 1011, Kxa 1021 and double encryption data E_{Ky}(E_{Kxa}(Iya)) 1121. Even if this data is leaked from the data storage server 120 of security service X, because there is no encryption key Ky, the double encryption data E_{Ky}(E_{Kxa}(Iya)) cannot be restored to plain text. In addition, similarly, because the encryption key Ky is not stored in the data storage server 120 of the security service X, the provider security service X cannot restore the data Iya, which should be protected, to plain text and cannot use it for advertisements or messages etc.

On the other hand, in the case 1, for example, as a result of a request for storage of data Iya from a data terminal of a user A, plain text Iya, encryption key Ky and encryption key Kxa are temporarily stored in the temporary storage part 102 between step S704 and step S710. In addition, similarly, as a result of a request for data Iya from a data terminal of a user A, plain text Iya, encryption key Ky and encryption key Kxa are temporarily stored in the temporary storage part 102 between step S1204 and step S1210. However, in any of these cases, data is deleted from the temporary storage part 102 at the same time as when encryption or display processes are completed (step S711 or step S1211) and not indefinitely as data in a database. As a result, there is lower risk of a database data leak from the data storage server of the security service X compared to a conventional method. In addition, although plain text data is stored temporarily in the data process storage of the security service X as stated above, generally it is difficult to obtain data which is the temporary storage part such as a main storage device by external access to a server. In addition, each type of law or regulation with the aim of personal data protection aims to protect databases which have accumulated personal data. The first embodiment can reduce a substantial risk with regards to data leak incidents compared to a conventional method, as well as can reduce the risk to web services and security service X of breaching laws and regulation which aim to protect personal data.

Furthermore, the following effect exists as a combination of the first and second effects. For example in the case 1, it is possible to store and use the data Iya input when the user A uses the web service Y in a state where the provider of the web service and the provider of the security service X which provide services for encrypting and storing this data cannot obtain this data.

A third effect of the present invention related to the present embodiment is that it is possible to restrict damage in the case where double encryption data and key are each leaked from the server which stores both or from a data process server of the security service X to a smaller range than a conventional method.

As described above, an encryption key managed by a web service and an encryption key and plain text user data which should be protected managed by the security service X are temporarily stored in the temporary storage part of the data process server of the security service X. For example, consider the case where the data which is temporarily stored in this temporary storage part is leaked from the data process server of security service X. Again referring to FIG. 13, among the processes in case 1, the encryption key Ky 1314 is presumed to be leaked from the web service Y and the encryption key Kxa 1316 and the double encryption data E_{ky}(E_{Kxa}(Iya)) are presumed to be leaked from the data storage server of the security service X. In this case, it is possible to calculate plain text Iya from E_{Ky}(E_{Kxa}(Iya)) if Ky and Kxa are used. However, even if the two encryption keys Ky and Kxa which are leaked are used, it is not possible to restore any of the encryption data in the case 2, the case 3, or the case 4 in FIG. 13 to plain text.

In other words, in the first and the second effects described above, the case was explained where even if the encryption data in the data storage server of security service X is all leaked, and either the encryption key managed by the web service and the encryption key managed by the security service is leaked, no double encryption data can be restored to plain text. According to the third effect, even if the encryption data in the data storage server of security service X is all leaked, and both the encryption key managed by the web service Y and the encryption key managed by the security service are leaked, the data which is can be restored to plain text is limited. By using a key in the present embodiment, even in the case where both encryption data and an encryption key are leaked, it is possible to reduce the level of damage compared to a conventional method.

Furthermore, as can be seen from FIG. 13, in the present embodiment, the encryption key managed by a web service is different for each web service, however, a common encryption key is used between several users of each web service. However, in the present embodiment a different encryption key may also be used for each user. In addition, an encryption key managed by the security service X is different for each user, however, even in the case where a user uses several web services, one encryption key is used by one user. However, in the present embodiment, different encryption keys may be used for each web service. If the number of encryption keys increases, it is possible to narrowly restrict the damage when an encryption key is leaked.

Furthermore, in the present embodiment, the encryption data table 123 which stores double encryption data and the encryption key table 124 which stores an encryption key such as Kxa in the security service X exist in the data storage server 120 of the same security service X. However, these two tables may also exist in different servers. Furthermore, in the case where these two tables exist in separate servers, the two servers may also be managed by different providers.

Furthermore, in the explanation of the present embodiment hereto, the data stored in the data storage server of the security service X is explained as data Iya which is input by user A from a data terminal in a state which cannot be restored to plain text by the web service Y or security service X. However, it is not necessary that this data is data input by user A, and the data may also be an encryption key for encrypting some form of data for example.

### Second Embodiment

First, an outline of the second embodiment is explained below. In the first embodiment, the server 150 of the web service Y sends the encryption key Ky held by the web service Y in step S705 of FIG. 7 and step S1204 of FIG. 12 to the data process server 100 of the security service X. FIG. 7 is a process for storing the data input by user A after a double encryption in the data storage server of the security service X. In addition, FIG. 12 is a process for getting data of user A which is double encrypted and stored in the security service X.

In the processes related to the first embodiment, the encryption key Ky held by the server of the web service Y is received by the server of the security service X and temporarily stored in the temporary storage part of the data process server 100. In the data process server of the security service X, the encryption key Ky is deleted after the processes in FIG. 7 and FIG. 12 are completed (step S711 and step S1211). As a result, there is safety even if double encrypted data is leaked from the data storage server of the security service X.

Generally, the provider of the web service Y sometimes does not wish the encryption key Ky to be stored in the server of the security service X even temporarily. The reason for this is that there is a possibility that the encryption key Ky stored temporarily in the temporary storage part 102 of the data process server of the security service X may be stored in a database storage part by intention or neglect of the provider of security service X. Originally, the encryption key Ky is used so that the data of user A who uses web service Y is not disclosed by the provider of the security service X. Therefore, it is possible to consider that it is not preferable to send the encryption key Ky to the data process server 100 under the management of the security service X. Furthermore, in the first embodiment, as is shown in FIG. 13, the encryption key Ky is common to all users of a web service. Therefore, if the provider of security service X stores the encryption key Ky in a database storage part and misuses the key, it is possible that the data of all the users of the web service Y may be restored to plain text.

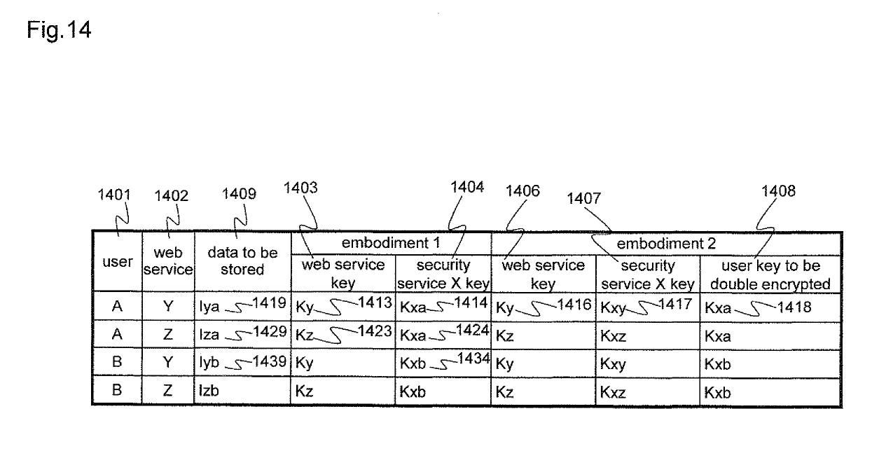

Therefore, as the second embodiment, an embodiment is explained for the realization of the same effects as in the first embodiment without sending the encryption key Ky held by web service Y to the server of the security service X. Referring to FIG. 14, in the first embodiment, the data Iya 1419 which is stored in the security service X is double encrypted using two keys Ky 1413 and Kxa 1414. However, in the present embodiment, three keys are used. First, data Iya 1419 is encrypted using the encryption key Kxa 1418 of user A in security service X and stored in the data storage server 120 as E_{Kxa}(IYA). On the other hand, the encryption key Kxa 1418 is double encrypted using the encryption key Kxy 1417 in the security service X and the encryption key Ky 1416 of the web service Y and stored in the data storage server 120 of the security service X as E_{Kxy}(E_{Ky}(Kxa)). Here, Kxy is an encryption key which is for a user of web service Y and which is stored in the security service X. However, Ky in the second embodiment is also en encryption key for a user of web service Y stored in the web service Y the same as in the first embodiment. Furthermore, while encryption keys such as Kxa and Kya are double encrypted in the second embodiment, data which is input by user A may be double encrypted using Ky and Kxy by the method in the second embodiment the same as in the first embodiment.

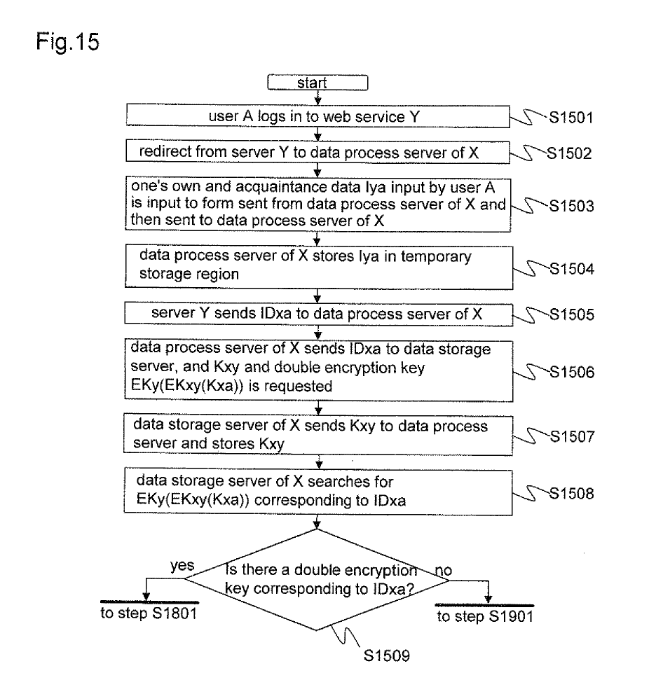

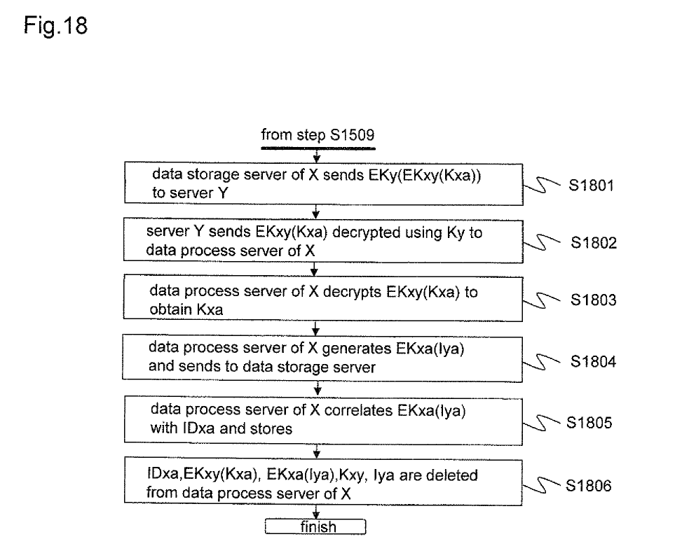

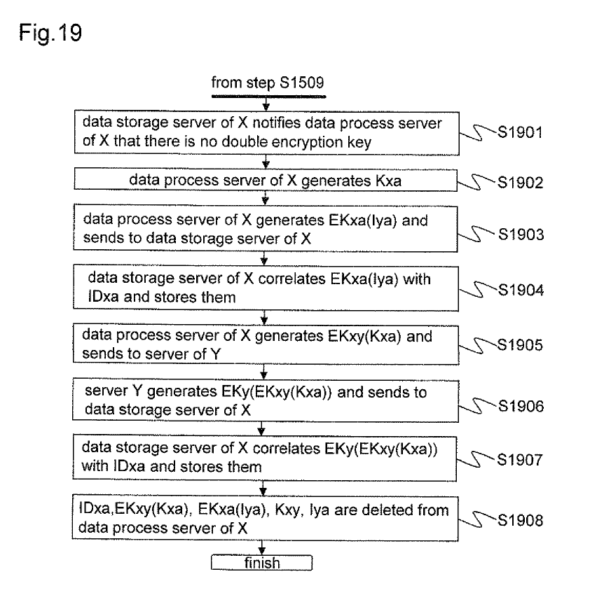

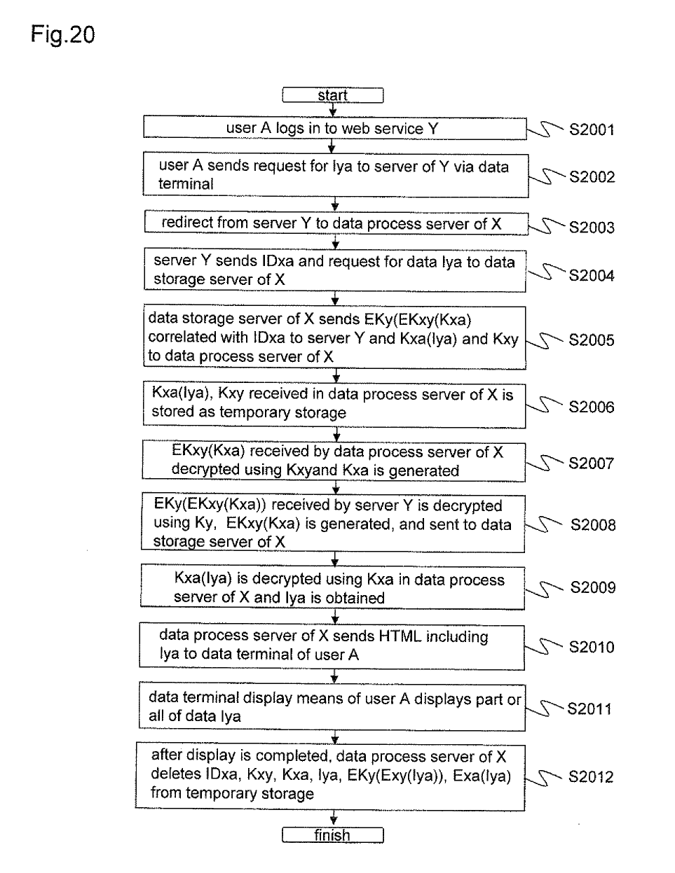

Next, the processes in the second embodiment are explained with references to the flow charts shown in FIG. 15, FIG. 18, FIG. 19, and FIG. 20. Now, user A logs in to web server Y (step S1501). At this time, the HTML generation part 155 of the server of web service Y generates an HTML code, and the sending and receiving part 151 sends the HTML code to the data terminal 170 of user A via network 190. The sending and receiving part 171 of the data terminal of user A receives the HTML code, the HTML analysis part 172 analyses the HTML code and the GUI display part 173 displays an image. At this point, because user A is logged in to web service Y, IDya which is for uniquely specifying user A in web service Y is stored in at least the temporary storage part 154 of the server of web service Y.

Now, the server of web service Y requests user A to input data which is not to be stored in the server 150 of web service Y. At this time, the connection between the server 150 of web service Y and the data terminal 170 of user A is redirected to the data process server 100 of security service X (step S1502). Next, the HTML generation part 108 of the data process server of the security service X generates an HTML code, and the sending and receiving part 101 sends the HTML code to the data terminal 170 of user A via network 190. The sending and receiving part 171 of the data terminal of user A receives the HTML code and after analysis by the HTML analysis part 172 an image is displayed by GUI display part 173. Here, an input form of the name and address of user A and an acquaintance of user A such as shown in FIG. 8 are displayed as an example of the present embodiment.

A web browser display window 800 is displayed on the GUI display part 173. Furthermore, a display 801 for displaying the fact that user A is currently using web service Y via a web browser may be displayed in the web browser display window 800. In the case where it is desired to display some form of data held by web service Y, this type of data is sent from the server 150 of web service Y to the data process server 100 of security service X, the data is temporarily stored in a plain text data region 104 and the HTML generation part 108 of the security service may generate an HTML code for displaying an image such as that shown in FIG. 8 using this data. For example, in the example shown in FIG. 8, data held by web service Y such as the name (Betty Thomas) 802 of user A is sent from the server 150 of web service Y to the data process server 100 of security service X and converted to an HTML code by the HTML generation part 108. In this case, the data received from the server 150 of web service Y is deleted together with other data in step S1806 or step S1908.

Next, user A inputs his own data and the data of an acquaintance using the input part 174 of the data terminal 170 of user A. Now, the characters input here are defined as data Iya, which is a result of concatenation of characters using spacing etc. The sending and receiving part 171 of the data terminal 170 of user A sends Iya to the data process server 100 of the service X via network 190 (step S1503). The sending and receiving part 101 of the data process server of service X receives Iya and is temporarily stored in the plain text data region 104 of the temporary storage part 102 (step S1504). Here, for simplification, although the characters input to several fields are shown as concatenated data Iya, these could also be divided into several data and stored.

Next, the search part 158 of the server 150 of web service Y searches the encryption table 153 for IDya which is the ID of user A stored in the temporary storage part 154 as a search key. An example of the encryption table 153 is shown in FIG. 9. Here, a column 920 of the security service X is searched for IDya 911 which is the ID of user A in the web service Y as a key and IDxa 921 which is the ID of user A in the security service X is obtained as a search result.

Next, the sending and receiving part 151 of the web service Y sends IDxa, which is the ID of user A in the security service X and which is the search result, to the data process server 100 of the security service X via network 190 (step S1505). Here, the point where the encryption key Ky of the web service Y is not sent to the data process server 101 of the security service X is different to the first embodiment. When the sending and receiving part 101 of the data process server of service X receives IDxa, IDxa is stored temporarily in the plain text data region 104 of the temporary storage part.

Next, the sending and receiving part 101 of the data process server of security service X sends a request for the encryption key Kxy and for the double encryption key E_{Ky}(E_{Ky}(Kxa)) of user A stored in the security service X to the data storage server 120 of service X. The request includes IDxa which is the ID of user A in the security service X received from the server 150 of web service Y in step S1505 described above and data Y for displaying a web service (step S1506).

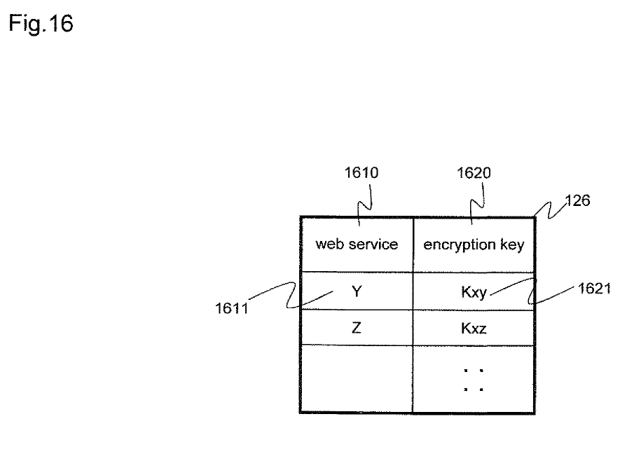

When the sending and receiving part 121 of the data storage server of security service X receives IDxa and Y, the search part 125 searches the service encryption key table 126 in the database storage part 122 for Y as a search key. An example of the service encryption key table 126 of the second embodiment is shown in FIG. 16. The search part searches for the encryption key Kxy 1621 of the web service Y and sends this to the data process server of the security service X via the sending and receiving part 121. The data process server of the security service X which receives this, stores it in an encryption key table 105 of a temporary storage part (step S1507). Furthermore, as can be seen from FIG. 14, the encryption key of the web service Y used in the first embodiment is Ky which is stored in the server 150 of web service Y. On the other hand, in the second embodiment, the point that two encryption keys related to web service Y are used is different to the first embodiment. In the present embodiment, the two web service Y encryption keys Ky and Kxy are used and Ky is stored in the server 150 of web service Y and Kxy is stored in the data storage server 120 of security service X. The processes in step S1507 are processes related to the encryption key Kxy.

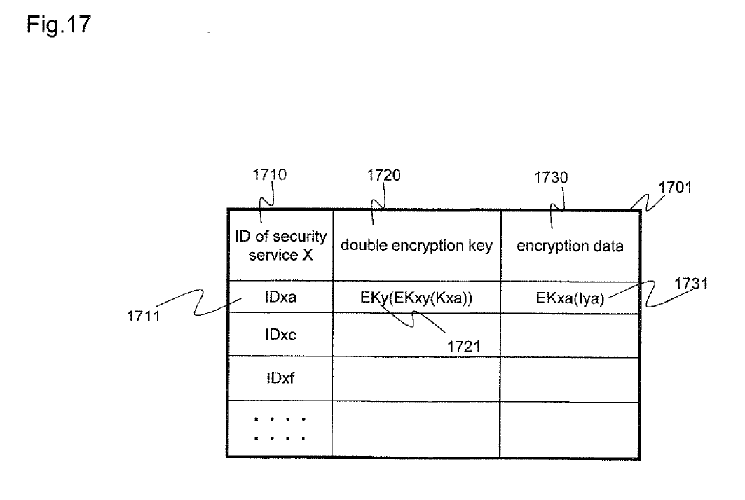

Next, the search part 125 of the data storage server of security service X searches an encryption key column of an encryption data table 123 for IDxa of user A sent from the data process server of security service X in step S1506 as a search key (step S1508). An example 1701 of the encryption data table in the present embodiment is shown in FIG. 17. The encryption data table 123 in the present embodiment correlates the double encryption key 1720 and the encryption data 1730 with the ID of each user and stores them. It is not possible to restore encryption data to plain text using the double encryption key stored in the encryption data table 1701. For example, in FIG. 17, the encryption data E_{Kxa}(Iya) 1731 is encrypted by the encryption key Kxa. Because the key Ky is stored in the server 150 of the web service Y, it is nor possible to restore the encryption key E_{Ky}(E_{Kxy}(Kxa)) stored in this table to plain text using the encryption key stored in the security service X. Therefore, it is not possible obtain the encryption key Kxa in the data storage server of the security service X and thus it is not possible to restore encryption data 1731 to plain text.

In the search in step S1508, the search part 125 searches for whether a double encryption key correlated with IDx which is the search key exists (step S1509). As in the example shown in FIG. 17, in the case where the double encryption key exists, the process proceeds to step S1801 in FIG. 18. Previously, in the case where the double encryption key corresponding to IDxa in the server of the security service X does not exist in the encryption data table 123 since it has not yet been generated, the process proceeds to step 1901 in FIG. 19.

Next, the process in the case where the double encryption key exists in the encryption data table 123 of the data storage server of security service X as in the example of FIG. 17 in step S1509 is explained using the flow chart in FIG. 18. First, the sending and receiving part 121 of the data storage server of security service X sends the double encryption key E_{Ky}(E_{Kxy}(Kxa)) searched in step S1509 to the server of web service Y (step S1801). Next, when the sending and receiving part 151 of the server of web service Y receives this, it is temporarily stored in the temporary storage part 154. Next, the double encryption key E_{Ky}(E_{Kxy}(Kxa)) which is received is decrypted by the decryption part 157 using the encryption key Ky stored in the encryption key table 153 and E_{Kxy}(Kxa) is obtained. Next, the sending and receiving part 151 sends this to the server of the data process service X of security service X (step S1802). At this time, because the encryption key Kxy is not stored in the server of web service Y, any further decryption of E_{Kxy}(Kxa) to obtain Kxa cannot be performed with the data stored in the server of web service Y. Following the processes in step S1802, E_{Ky}(E_{Kxy}(Kxa)), which is received from the data storage server of security service X, and E_{Kxy}(Kxa), which is generated, are deleted from the temporary storage part 154.

Next, the sending and receiving part 101 of the data process server of security service X receives E_{Kxy}(Kxa) sent from the server of web service Y in step S1802, and is temporarily stored in an encryption data region 103 of a temporary storage part. Next, an encryption part 107 decrypts E_{Kxy}(Kxa) using the encryption key Kxy stored in the encryption key table in step S1507, and Kxa is obtained (step S1803). Next, the data Iya stored in the plain text data region 104 of a temporary storage part in step S1504 is encrypted using the encryption key Kxa obtained in step S1803 and E_{Kxa}(Iya) is generated. Next, the sending and receiving part 101 sends E_{Kxa}(Iya) to the data storage server of security service X (step S1804). Next, the sending and receiving part 121 of the data storage server of security service X receives E_{Kxa}(Iya). Next, this is correlated with IDxa of user A and stored in the encryption data table 123 of the database storage part (step S1805). E_{Kxa}(Iya) in the encryption data table 1701 in FIG. 17 is stored in step S1805. Next, IDxa, E_{Kxy}(Kxa), E_{Kxa}(Iya), Kxy, and Iya which are stored in the storage part of the data process server of security service X are deleted (step S1806).

The case where the double encryption key E_{Ky}(E_{Kxy}(Kxa)) is stored in the data storage server of security service X before user A inputs data Iya in step S1503 to the data terminal, has been explained using the flow chart shown in FIG. 18. Next, the case where the double encryption key E_{Ky}(E_{Kxy}(Kxa)) is no stored in the data storage server of security service X at the time data Iya is input is explained while referring to FIG. 19.

Referring to FIG. 19, in the case where a double encryption key correlated with IDxa in step S1509 is not stored in the encryption data table 123 of the data storage server of security service X, the sending and receiving part 121 of the data storage server of security service X notifies the data process server of security service X that there is no double encryption key correlated with IDxa (step S1901). When the sending and receiving part 101 of the data process server of security service X receives this notification, an encryption key generation part 111 generates an encryption key Kxa of user A (step S1902). Next, the data Iya stored in the plain text data region 104 of a temporary storage part in step S1504 is encrypted using the encryption key Kxa and E_{Kxa}(Iya) is generated. Next, the sending and receiving part 101 sends this to the data storage server 120 (step S1903).

The sending and receiving part 121 of the data storage eserver 120 of security service X receives E_{Kxa}(Iya), correlates this with IDxa of user A and stores them in the encryption data table 123 of the database storage part (step S1904). E_{Kxa}(Iya) 1931 in the encryption data table 170 in FIG. 17 is equivalent to this.

Next, the encryption part 107 of the data process server of security service X encrypts the encryption key Kxa generated in step S1902 using the encryption key Kxy stored in the encryption key table 105 in step S1507 and E_{Kxy}(Kxa) is obtained. Next, the sending and receiving part 101 correlates this with IDxa and sends them to the server 150 of web service Y (step S1905).

Next, the sending and receiving part 151 of the server of web service Y receives E_{Kyx}(Kxa). The encryption part 159 encrypts this using the encryption key Ky stored in the encryption key table 153 and generates E_{Ky}(E_{Kxy}(Kxa)). Next, the sending and receiving part 151 correlates this with IDxa and sends them to the server 120 of security service X (step S1906). The server of web service Y deletes E_{Ky}(E_{Kxy}(Kxa)) which is generated and E_{Kxy}(Kxa) which is received from the temporary storage part 154.

Next, the sending and receiving part 121 of the data storage server of security service X receives E_{Ky}(E_{Kxy}(Kxa)), correlates this with IDxa and stores them in the encryption data table 123 (step S1907). Following this, the data process server of security service X deletes IDxa, E_{Kxy}(Kxa), Kxy, Kxa(Iya) and Iya stored temporarily in the non-volatile storage region (step S1908) and the process is completed. Furthermore, as can be seen from FIG. 17, in the second embodiment, the double encryption key E_{Ky}(E_{Kxy}(Kxa)) 1721 and the encryption data E_{Kxa}(Iya) 1731 are stored in the same data storage server of security service X. However, a double encryption key and encrypted data may be stored in different servers.

Next, a process whereby user A browses his own data and an acquaintance's data Iya input in step S1503 via the web service Y is explained succinctly using the flow chart in FIG. 20.

Now, user A logs in to web service Y (step S2001). At this time, the result of an analysis of an HTML code sent from the web service Y is displayed on the GUI display part 173. Here, an operation is carried out for requesting data Iya related to user A himself and an acquaintance input via input part 174 by user A in step S1503. Then, the sending and receiving part 171 of the data terminal of user A sends a display request of Iya to the server 150 of web service Y via network 190 (step S2002). The sending and receiving part 101 of web service Y which receives this request redirects the connection to the data terminal 170 of user A to the data process server 100 of security service X (step S2003).

Furthermore, the search part 158 of the server of web service Y searches the encryption key table 153 which is in the database storage part for IDya for uniquely identifying user A on web service Y as a search key. IDxa 921 obtained as the search result is sent together with a request for Iya to the data storage server 120 of security service X via network 190 (step S2004).

When the sending and receiving part 121 of the data storage server of the security service X receives this request, the search part 125 searches the encryption data table 123 for the received IDxa as a search key, and E_{Kxa}(Iya) 1731 stored in step S1805 or step S1904 and E_{Ky}(E_{Kxy}(Kxa)) 1721 are obtained. Next, the sending and receiving part 121 sends E_{Kxa}(Iya) and Kxy correlated with IDxa to the data process server 100 of security service X. Furthermore, the sending and receiving part 121 sends E_{Ky}(E_{Kxy}(Kxa)) correlated with IDxa to the server 150 of web service Y.

The sending and receiving part 101 of the data process server of security service temporarily stores E_{Kxa}(Iya) and Kxy received from the data storage server 120 of security service X to the encryption data region 103 (step S2006).

Next, the sending and receiving part 151 of the server of web service Y searches the encryption key table 153 for IDxa sent from the data storage server of security service X in step S2005 as a search key and encryption key Ky of user A is obtained. Next, E_{Kxy}(Kxa) is generated by decrypting E_{Ky}(E_{Kxy}(Kxa)) received in the same step S2005 using the encryption key Ky, and this is temporarily stored in the temporary storage part 154. Next, the sending and receiving part 151 sends E_{Kxy}(Kxa) to the data process server 100 of security service X via the network 190 (step S2007). Following this, the received E_{Ky}(E_{Kxy}(Kxa)) and generated E_{Kxy}(Kxa) are deleted from the temporary storage part 154.

Next, the sending and receiving part 101 of the data process server of security service X receives E_{Kxy}(Kxa) and this is temporarily stored in an encryption data region 103 of a temporary storage part. Next, a decryption part 106 decrypts Kxy(Kxa) using Kxy stored in the encryption data region 103 in step S2006, and Kxa of user A is obtained (step S2008). Furthermore, Kxa(Iya) stored in the encryption data region 103 in step S2106 is decrypted using Kxa, data Iya is obtained and this is temporarily stored in the plain text data region 104 (step S2009). Next, the HTML generation part 108 generates an HTML code which includes this data Iya. The sending and receiving part 101 sends the HTML code which includes the data Iya to the data terminal 170 of user A (step S2010). The sending and receiving part 171 of the data terminal of user A receives the HTML code and after analysis by the HTML analysis part 172 the result is displayed by GUI display part 173 (step S2011). Here, the data which is displayed may be a part or all of the data Iya or may include data other than Iya. When the display of data which includes a part or all of Iya is completed, this notification is sent to the data process service of security service X. The data process server of security service X which receives this notification deletes IDxa, Kxy, Kxa, Iya, E_{Ky}(Eₓₐ(Iya)) and E_{Kxy}(Kxa) which are stored in the temporary storage part 102 (step S2012).

In the first embodiment, the data Iya which is stored is directly double encrypted using the encryption key Ky which is stored in the server of web service Y and the encryption key Kxa which is stored in the data storage server of security service X. However, in the second embodiment, data Iya is encrypted using the encryption key Kxa. In addition, the encryption key Kxa is double encrypted using the encryption key Ky stored in the server of web service Y and Kxy stored in the data storage server of security service X. This is the biggest difference between the first and second embodiments.

In the second embodiment, because the encryption key Ky is not received by the security service X, the processes of the data storage server of security service X and the data storage server may be performed in one server.

Next, the effects of the present embodiment are explained. The same as the first effect explained in the first embodiment, the first effect is that it is possible to provide each web service without storing data input by a user, for example data which should be protected such as Iya in the server of a web service. In the present embodiment, referring to FIG. 9, only IDya and the encryption key Ky held by web service Y and IDxa of security service X are stored in the server of web service Y. As a result, data Iya input by user A to the data terminal is not stored in the server 150 of web service Y. Therefore, as explained in the first effect of the first embodiment, the second embodiment has the effect of reducing the risk of data leaks from the server of web service Y and prevention of using a user's data by the provider of web service Y.

An effect of the second embodiment, the same as the second effect related to the first embodiment, is that it is possible to realize a high level of safety when storing data Iya input by user A in the data storage server of the security service X. The encryption key which is required for decrypting the encryption data E_{Kxa}(Iya) which is stored in the data storage server of security service X is Kxa. However, this Kxa is double encrypted in the data storage server of security service X and is stored as E_{Ky}(E_{Kxy}(Kxa)). In order to obtain Kxa from the double encrypted E_{Ky}(E_{Kxy}(Kxa)) the encryption key Ky stored only in the server of web service Y is required. Therefore, data Iya cannot be restored to plain text by the provider of security service X. In addition, even if the encryption data or double encryption key are leaked from the data storage server 120 of security service X, plain text of data Iya cannot be obtained. Although plain text Iya or encryption key Kxa are temporarily stored in the temporary storage part 102 of the data process server of security service X, these are not stored as a database in a database storage part. As a result, it is difficult to obtain plain text data Iya by accessing from the outside of the security service X.

A third effect related to the second embodiment is that encryption key Ky stored by the server 150 of web service Y is not sent to the data process server 100 of security service X. The third effect related to the second embodiment is an effect not referred to in the first embodiment. In the first embodiment, Ky is sent to the data process server of security service X, temporarily stored in a temporary storage part and using this, the data Iya is encrypted or decrypted. The encryption key Ky held by the web service Y is not stored in the data storage server of security service X and is deleted from the data process server of security service X after the encryption or decryption processes are completed (step S711 or step S1211). However, in actual fact, the provider of web service Y often does not want to send the encryption key Ky to a server under the management of security service X. If the provider of security service X stores Ky which is temporarily stored in the data process server in the data storage server, it will be possible for the provider of security service X to obtain the data Iya input by user A to web service Y by combining with the key Kxa of security service X. Furthermore, if Ky is stored by the provider of security service X, it will be possible to obtain all the user data of web service Y. Again referring to FIG. 14, for example, if Ky is stored by the provider of security service X, it will be possible to obtain data Iyb 1439 input by user B by combining with the encryption key Kxb 1434 of user B which user B has stored.

However, according to the present embodiment, it is not necessary to send the encryption key Ky to the data process server of security service X. Therefore, there is no method by which the provider of security service X obtains the encryption key Ky.

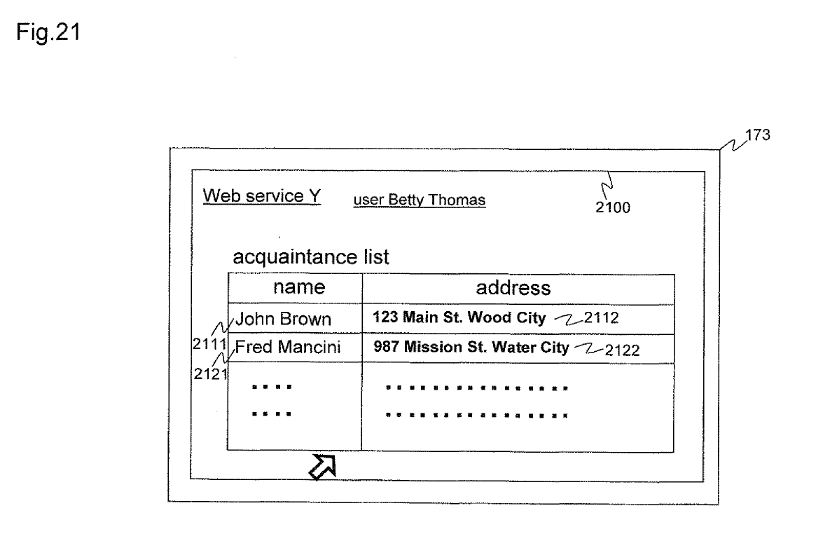

A fourth effect of the present embodiment is that it is easy for a user who stores data in the security service X to use several web services simultaneously. The fourth effect of the present embodiment is an effect not referred to in the first embodiment. User A logs in to the web service Y and by the process explained with reference to FIG. 20, the data Iya previously input while user A is using web service Y is assumed to be displayed on the data terminal of user A (step S2011). Furthermore, in this state, user A is assumed to want to also simultaneously display data Iza input during previous use of web service Z. For example, as shown in FIG. 8, web service Y is an address record service which manages one's own and an acquaintance's name and address. In addition, the web service Z is a different address recording service. At this time, it is convenient for user A if an acquaintance list managed separately by web service Y and service Z can be displayed together on one screen as is shown in the example of FIG. 21 for example. FIG. 21 is a display screen when user A uses web service Y. A web browser window 2100 is displayed in the GUI display part 173. As is shown in the flow chart in FIG. 20, an HTML code in the screen of FIG. 21 is generated by the HTML generation part 108 of the data process server of security service X. Now, in FIG. 21, the name John Brown 2111 who is an acquaintance of user A and his address 2112 are assumed to be data Iya input during use of web service Y by user A. In addition, the name Fred Mancini 2121 who is an acquaintance of user A and his address 2122 are assumed to be data Iza input during use of web service Z by user A. As is shown in FIG. 21, if it is possible to browse data of acquaintances separated over several web services together, the convenience of user A's address record is improved.

In the explanation above, for the purposes of simplification, the web service Y and web service Z are explained as address recording services. However, each web service may also be a provider of electronic mail, chat, SNS (Social Networking Service), voice telephone service, product sale or product delivery service.

In the second embodiment, at the point where data Iya input by user A to web service Y is displayed on display part 173 by a process explained referring to FIG. 20, encryption key Kxa is temporarily stored in a plain text state in the temporary storage part 102 of the data process server of security service X. Here, again referring to FIG. 14, in the present embodiment, data Iya 1419 and data Iza 1439 are stored in the data storage server 120 while being encrypted using the same encryption key Kxa. As a result, the data process server of security service X does not perform a process equivalent to step S2001 to S2009 with regards to Iza and the server, data Iya and Iza cannot be displayed on the same screen as is shown in FIG. 21.

Again referring to FIG. 14, in the case of the first embodiment, data Iya 1419 is double encrypted using Kxa 1414 and Ky 1413 in the data storage server 120 of security service X, and stored as E_{Ky}(E_{Kxa}(Iya)). On the other hand, Iza 1429 is double encrypted using Kxa 1424 and Kz 1423 and stored as E_{Kz}(E_{Kxa}(Iza)). In order for the data process server of security service X to generate an HTML code for the display as shown in FIG. 21, user A is required to perform a process equivalent to step S2001 to S2009 in FIG. 20 with regards to both web service Y and web service Z. As a result, user A is required to perform further operations and more processes are required in each server of security service X, and the servers of web service Y and web service Z. However, in the present embodiment, it is possible to simply display a screen as shown in FIG. 21. In the screen in FIG. 21, it is possible add or change in addition to display the data. In this case, the processes shown in FIG. 15, FIG. 18, FIG. 19 and FIG. 20 are performed.

That is, with the method of the second embodiment, it is possible to cross link several web services as in FIG. 21 despite the fact that the data input when user A who uses web service Y and web service Z uses each service cannot be obtained by the provider of web service Y, the provider of web service Z or the provider of security service X, and it is possible to provide a service that is impossible under conventional methods.

According to an embodiment of the present invention, it is possible for a user to use data held by and dispersed in a certain web service in a different web service. Despite this being realized, user data held in each web service cannot be obtained from another web service provider. En one embodiment of the present invention, user data dispersed in each web service is merged and sent to a data terminal of a user, and a security service which provides a function for encryption and storage mediates the data of a user dispersed in each web service. However, the provider of this security service cannot obtain any of the data held by a connected web service user.

1-32. (canceled)

33. A secret information management system for a storage process and a browsing process of secret information on one or a plurality of servers comprising:
a first server; and
a second server,
wherein
(1) in the storage process,
the secret information transmitted by a user who uses a first service provided by the first server connected via a network is received via the network and is stored in a first temporary storage region;
the secret information stored in the first temporary storage region is encrypted in a state where decryption is only possible by using both a first encryption key, which is managed by a provider by the first service, and a second encryption key, which is managed by a provider other than the provider of the first service, and encrypted secret information is generated;
the encrypted secret information is stored in an information storage region; and
the secret information, which is stored in the first temporary storage region, is deleted and
(2) in the browsing process,
the secret information is decrypted from the encrypted secret information using both the first encryption key and the second encryption key and is stored in a second temporary storage region;
the secret information stored in the second temporary storage region is received via the network by the first server or the second server which provides a second service which is provided by a provider different from the provider of the first service; and
the secret information, which is stored in the second temporary region, is deleted.

34. The secret information management system according to claim 33, wherein in the storage process, when the secret information stored in the first temporary storage region is encrypted and the encrypted secret information is generated, the first encryption key is received via the network from the first server, the secret information stored in the first temporary storage region is encrypted using the first encryption key, which is received, and the second encryption key managed by the secret information management system, and the first encryption key, which is received, is deleted following the encryption process, and in the browsing process, when the secret information is decrypted from the encrypted secret information, the first encryption key is received via the network from the first server, the secret information is decrypted from the encrypted secret information using the first encryption key which is received and the second encryption key, and the first encryption key, which is received, is deleted after the decryption process.

35. The secret information management system according to claim 33, wherein in the storage process, when the secret information stored in the first temporary storage region is encrypted and the encrypted secret information is generated, the secret information stored in the first temporary storage region is encrypted using a third encryption key stored as an encryption key which is in a state where the third encryption key can be decrypted only by using both the first encryption key and the second encryption key, and the third encryption key is deleted after the encryption process.

36. The secret information management system according to claim 35, wherein in the browsing process, when the secret information is decrypted from the encrypted secret information, the encryption key is transmitted to the first server, encryption key information generated by decrypting the encryption key using the first encryption key from the first server is received, the third encryption key is generated by decrypting the encryption key information, which is received, using the second encryption key, and the third encryption key is deleted after decrypting the secret information from the encrypted secret information.

37. The secret information management system according to claim 33, wherein when the encrypted secret information is stored in the information storage region, the encrypted secret information is correlated with an identification tag for uniquely identifying a user and is stored, and the second encryption key is correlated with identification tag and is stored within the secret information management system.

38. The secret information management system according to claim 33, wherein one or both of the first encryption key and the second encryption key are non-symmetric keys comprised from a public key used for encryption and a secret key used for decryption.

39. The secret information management system according to claim 33, wherein in the browsing process, the secret information stored in the second temporary storage region is transmitted to a second server which provides the second service provided by a provider different from the provider of the first service.

40. The secret information management system according to claim 37, wherein the first server authenticates the user in the storage process and/or in the browsing process and transmits the identification key for uniquely identifying the user to the secret information management system.

41. The secret information management system according to claim 33, wherein
(1) in the storage process
a second secret information transmitted by the user who uses the second service is received via the network and is stored in the first temporary storage region;
the second secret information, which is stored in the first temporary storage region, is encrypted in a state where decryption is only possible by using both the third encryption key, which is managed by the provider of the second service, and the second encryption key, and a second encrypted secret information is generated;
the second encrypted secret information is stored in an information storage region; and
the second secret infatuation, which is stored in the first temporary storage region, is deleted; and
(2) in the browsing process
the second secret information is decrypted from the second encrypted secret information using both the third encryption key and the second encryption key and is stored in the second temporary storage region;
the second secret information, which is stored in the second temporary storage region, is transmitted to the first server or the second server via the network; and
the second secret information, which is stored in the second temporary storage region, is deleted.

42. A server which provides a service via a network, comprising:
a first temporary storage region; and
a second temporary storage region,
where in the server received a login request of a user; and provides a user interface for inputting secret information to be transmitted to a secret information management system by redirecting the user to the secret information management system installed on one or a plurality of servers connected via a network, the secret information management system performing a storage process and browsing process of the secret information on the one or plurality of servers;
wherein
(1) in the storage process,
the secret information transmitted by the user is received via the network and is stored in the first temporary storage region;
the secret information, which is stored in the first temporary storage region, is encrypted in a state where decryption is only possible by using both a first encryption key managed by a provider of the first service and a second encryption key managed by a provider other than the provider of the first service, and an encrypted secret information is generated;
the encrypted secret information is stored in an information storage region; and
the secret information, which is stored in the first temporary storage region, is deleted and
(2) in the browsing process,
the secret information is decrypted from the encrypted secret information using both the first encryption key and the second encryption key and is stored in the second temporary storage region;
the secret information, which is stored in the second temporary storage region, is transmitted via the network to the server or a different server which provides a different service provided by a provider different from a provider of the service; and
the secret information, which is stored in the second temporary region, is deleted.

43. The server which provides a service via a network according to claim 42, wherein the server stores the first encryption key, and in the storage process, when the secret information, which is stored in the first temporary storage region, is encrypted and the encrypted secret information is generated, the first encryption key is received via the network from the server, the secret information stored in the first temporary storage region is encrypted using the first encryption key, which is received, and the second encryption key managed by the secret information management system, and the first encryption key, which is received, is deleted after the encryption process, and in the browsing process, when the secret information is decrypted from the encrypted secret information, the first encryption key is received via the network from the server, the secret information is decrypted from the encryption secret information using the first encryption key, which is received, and the second encryption key, and the first encryption key, which is received, is deleted after the decryption process.

44. The server which provides a service via a network according to claim 42, wherein the server stores the first encrypted key, and in the storage process, when the secret information, which is stored in the first temporary storage region, is encrypted and the encrypted secret information is generated, the secret information, which is stored in the first temporary storage region, is encrypted using a third encryption key stored as an encryption key which is in a state where the third encryption key can be decrypted only by using both the first encryption key and the second encryption key, and the third encryption key is deleted after the encryption process.

45. The server which provides a service via a network according to claim 44, wherein in the browsing process, when the secret information is decrypted from the encryption secret information, the encryption key is transmitted to the server, the encrypted key information is generated by decrypting the encryption key using the first encryption key from the server is received, the third encryption key is generated by decrypting the encryption key information, which is received, using the second encryption key, and the third encryption key is deleted after decrypting the secret information from the encrypted secret information.

46. The server which provides a service via a network according to claim 42, wherein when the encrypted secret information is stored in the information storage region, the encrypted secret information is correlated with an identification tag for uniquely identifying a user and is stored, and the second encryption key is correlated with identification tag and is stored within the secret information management system.

47. The server which provides a service via a network according to claim 42, wherein one or both of the first encryption key and the second encryption key are non-symmetric keys comprised from a public key used for encryption and a secret key used for decryption.

48. The server which provides a service via a network according to claim 42, wherein in the browsing process, the secret information, which is stored in the second temporary storage region, is transmitted to a different server which provides the different service provided by a different provider from the provider of the service.

49. The server which provides a service via a network according to claim 42, wherein in the storage process and/or the browsing process an identification tag for uniquely identifying the user from identification information specified by a login request of the user is obtained and transmitted to the secret information management system.

50. A secret information management system comprising:
an information process server; and
an information storage server for performing a storage process and a browsing process respectively;
wherein
(1) In the storage process,
the information process server receives secret information sent by a user of a different server connected via a network and stores the secret information in a first temporary storage region;
a first encryption key from the different server is received;
a second encryption key from the information storage server is received;
the secret information, which is stored in the first temporary storage region, is encrypted using the first encryption key and the second encryption key and an encrypted secret information is generated;
the secret information, which is stored in the first temporary storage region, is deleted after transmitting the encrypted secret information to the information storage server; and
the information storage server stores the encrypted secret information received from the information process server;
(2) in the browsing process,
the information storage server transmits the second encrypted key and the encrypted secret information to the information process server;
the information process server receives the first encrypted key from the different server;
the second encryption key and the encryption secret information is received from the information storage server;
the encrypted secret information to the secret information is decrypted using the first encryption key and the second encryption key and is stored the secret information in a second temporary storage region; and
the secret information, which is stored in the second temporary storage region, is deleted after the secret information is transmitted to the information process server and a server other than the information storage server.

51. An information process server for communicating with an information storage server for performing a storage process and a browsing process of secret information respectively, comprising:
a first temporary storage region; and
a second temporary storage region,
wherein:
(1) in the storage process
a secret information is transmitted by a user who uses a service provided by a first server and storing the secret information in the first temporary storage region;
a first encryption key is received from the first server;
a second encryption key is received from the information storage server;
the secret information, which is stored in the first temporary storage region, is encrypted using the first encryption key and the second encryption key and an encrypted secret information is generated;
the secret information, which is stored in the first temporary storage region, is deleted after transmitting the encryption secret information to the information storage server; and
(2) in the browsing process
the information storage server sends the second encryption key and the encryption secret information to the information process server;
the first encryption key is received from the different server;
the second encryption key and the encrypted secret information is received from the information storage server;
the encrypted secret information is decrypted to the secret information using the first encryption key and the second encryption key and is stored the secret information in the second temporary storage region; and
the secret information, which is stored in the second temporary storage region, is deleted after the secret information is sent to the information process server and a server other than the information storage server.

52. A storage process server for communicating with an information process server for performing a storage process and a browsing process of secret information respectively, comprising:
a receiver;
a transmitter; and
a database storage,
wherein:
(1) in the information storage process,
an identification tag for uniquely identifying a user of a different server connected via a network is received by the receiver;
a first encryption key correlated with the identification tag and stored in the information process server is transmitted by the transmitter;
an encrypted secret information is produced by encrypting the secret information transmitted by a user of the different server using the second encryption key and the first encryption key, which is received by the receiver from the different server, and is correlated with the identification tag and the secret information key and the identification tag are stored in the database storage; and
(2) in the browsing process,
the identification tag is received by the receiver from a server other than the information process server; and
the first encryption key and the encrypted secret information, which is correlated with the identification tag, are transmitted by the transmitter to the information process server.
